(19) United States
(12) Patent Application Publication
(10) Pub. No.: US 2025/0099987 A1
(43) Pub. Date: Mar. 27, 2025

(54) ROTARY SPRAY NOZZLES

(71) Applicant: Sonny's HFI Holdings, LLC, Wilmington, DE (US)

(72) Inventor: Ian Taylor, Inver Grove Heights, MN (US)

(21) Appl. No.: 18/894,299

(22) Filed: Sep. 24, 2024

Related U.S. Application Data
(60) Provisional application No. 63/540,442, filed on Sep. 26, 2023.

(51) Int. Cl. B05B 3/04

(52) U.S. Cl. CPC B05B 3/0463

(57) ABSTRACT

A rotary spray nozzle includes an internal chamber, an inlet channel, a discharge channel for discharging fluid from the nozzle, and a rotor arranged within the internal chamber. The rotor includes an internal flow channel for transmitting fluid therethrough, a cup-shaped external channel concentrically arranged about a longitudinal axis of an external surface of the rotor body for temporarily retaining the fluid, and a rotor skirt arranged distal to the external channel. Fluid in the nozzle causes the rotor to spin and exerts a force on the rotor when briefly retained in the external channel and when contacting the rotor skirt to cause a rotor outlet to seal against a rotor seat such that fluid from the rotor outlet is discharged from the discharge channel in a continuous stream defining a circular spray pattern. The rotor may include a spherical region for frictionally engaging with the internal chamber.

### CROSS-REFERENCE TO RELATED APPLICATIONS

This application claims priority to U.S. Provisional Patent Application No. 63/540,442, filed Sep. 26, 2023, entitled “Rotary Spray Nozzles,” which is incorporated by reference herein, in the entirety and for all purposes.

### TECHNICAL FIELD

Disclosed are rotary spray nozzles for use in pressurized spraying applications.

### BACKGROUND

Rotary spray nozzles are commonly used in spray applications such as in cleaning operations including sewer cleaning and in automated car washes. Rotary spray nozzles are constructed of a housing, along with an internal rotor and one or more elastomeric O-rings for increasing friction and controlling rotation speed. Representative spray nozzles of the prior art include U.S. Pat. Nos. 4,802,628, 4,811,906, 4,913,346, 5,039,013, 5,060,862, 5,141,158, 5,217,166, 5,236,126, 5,328,097, 5,332,155, 5,395,053, 5,456,413, 5,551,635, 5,597,119, 5,598,975, 5,871,023, 5,908,349, 5,922,131, 5,941,458, 6,027,040, 6,196,475, 6,250,566, 8,500,042, 9,731,303 and U.S. Patent Publication Nos. US 2002/0107132, US 2003/0209611, US 2008/0035755.

### SUMMARY

A rotary spray nozzle, according to certain implementations of the present disclosure, may include a housing defining an internal chamber. A first end of the housing may include an inlet channel configured to deliver fluid to the internal chamber. A second end of the housing opposite the first end may include a discharge channel configured to discharge the fluid from the nozzle. A rotor may be arranged within the internal chamber. The rotor may include a rotor body with an inlet end, an outlet end, and an internal flow channel extending therebetween for transmitting fluid through the rotor body. A cup-shaped external channel of the rotor may be concentrically arranged about a longitudinal axis of an external surface of the rotor body, and the external channel may include an open end for receiving the fluid and a closed end for temporarily retaining the fluid. A rotor skirt of the rotor may be arranged distal to the external channel and concentrically arranged about the longitudinal axis of the external surface. As the fluid enters the inlet member and is discharged against a surface of the internal chamber, the fluid may cause the rotor to spin and exert force against the external surface of the rotor body as the fluid enters and is retained in the external channel and as the fluid contacts the rotor skirt, such that a rotor outlet at the outlet end is forced into and seals against a rotor seat of the second housing member, where the fluid from the rotor outlet is discharged from the discharge channel and assumes a generally continuous stream defining a circular spray pattern.

In various implementations and alternatives, the external surface of the rotor body may define a spherical region, and the external channel may be defined at a proximal end of the spherical region. In such implementations, a sleeve may be positioned against the internal chamber and may define a contact region configured to frictionally engage with a contact portion of the rotor body, and the contact portion may be defined at least in part by the spherical region. In such implementations, the rotor skirt may be arranged distal to the spherical region. In some cases, the rotor skirt may be at least partially received in a rotor skirt relief channel defined in a distal end of the internal chamber. The rotor skirt relief channel may be arranged concentric to the discharge channel. In some cases a sidewall of the rotor seat and a sidewall of the internal chamber may define the rotor skirt relief channel.

In various implementations and alternatives, one or more angled discharge channels may extend from the inlet channel of the housing, and the angled discharge channels may be configured to deliver fluid to the internal chamber at an angle offset from a longitudinal axis of the housing. In addition or alternatively, the rotor may include one or more flanges extending from the inlet end to the external channel. In addition or alternatively, the rotor skirt may be at least partially received in a rotor skirt relief channel as provided herein.

A rotary spray nozzle, according to other implementations may include a housing defining an internal chamber; an inlet channel; a discharge channel; and a rotor arranged within the internal chamber. The rotor may include a rotor body, a cup-shaped external channel concentrically arranged about an external surface of the rotor body with an open end for receiving the fluid and a closed end for temporarily retaining the fluid; a spherical region arranged distal to the external channel and concentrically arranged about the longitudinal axis of the external surface; and a rotor skirt arranged distal to the spherical region and concentrically arranged about the longitudinal axis of the external surface. As the fluid enters the inlet member and is discharged against a surface of the internal chamber, the fluid may cause the rotor to spin and exert force against the external surface of the rotor body as the fluid enters and is retained in the external channel and as the fluid contacts the rotor skirt, such that a rotor outlet at the outlet end is forced into and seals against a rotor seat of the second housing member, as the spherical region contacts a surface of the internal chamber to provide frictional resistance to the rotor, whereby the fluid from the rotor outlet is discharged from the discharge channel and assumes a generally continuous stream defining a circular spray pattern.

In various implementations and alternatives, a sleeve may be positioned against the internal chamber and may define a contact region for contacting the spherical region. In some cases, the sleeve may be formed of a material that differs from a material of the spherical region. For instance, at least a portion of the spherical region may be formed of a metal.

In various implementations and alternatives, the spherical region may extend along at least one-third of a length of the rotor. In such cases, the external channel may be arranged at a proximal end of the spherical region. In some cases, the external channel and the rotor body may be integrally formed, and the spherical region may be formed a different material therefrom. Alternatively, the external channel and the spherical region may be integrally formed of the same material.

In various implementations and alternatives, the rotor flow channel may include a single set of flow straightener tubes extending from an inlet thereof, and the flow straightener tubes may be directly fluidly coupled to a nozzle tip defining the rotor outlet.

A rotary spray nozzle, according to still other implementations of the present disclosure, may include a housing constructed of two housing members each formed of a polymeric material. The two housing members may define an external surface at an exterior of the nozzle and an internal surface. The internal surfaces of the two housing members may define an internal chamber. An inlet member may be coupled to an inlet channel defined in a first housing member of the two housing members, and may be configured to deliver fluid to the internal chamber. A discharge channel may be defined in a second housing member of the two housing members, and the discharge channel may be configured to discharge the fluid from the nozzle. A rotor may be arranged within the internal chamber, and the rotor may include a rotor body defined by an inlet end, a contact portion and an outlet end. The contact portion may be configured to frictionally engage a contact region of the internal chamber as the outlet end resides within a rotor seat of the second housing member at the discharge channel, and the rotor body may include a rotor flow channel defined by a rotor inlet, a rotor lumen and a rotor outlet. As the fluid enters the inlet member and is discharged tangentially against a surface of the internal chamber, the fluid may cause the rotor to spin, and the contact portion and the contact region may provide frictional resistance to the rotor such that the fluid discharged from the rotor outlet assumes a generally continuous stream defining a circular spray pattern.

In various implementations and alternatives, the first housing member and the second housing member may be non-detachably joined, such as by spin welding.

In various implementations and alternatives, the rotor may further include a rotor skirt surrounding a distal portion of the rotor body, where the fluid exerts force against the rotor skirt causing the outlet end of the rotor to be forced and seal against the rotor seat to cause the fluid discharged from the rotor outlet to be discharged from the discharge channel. In such cases, the rotor skirt may be at least partially received in a rotor skirt relief channel defined in a distal end of the internal chamber. In such cases, the rotor skirt relief channel may be defined concentrically around the discharge channel.

In various implementations and alternatives, a sleeve may be positioned against the internal chamber and may define the contact region. In such cases, the sleeve may be formed of a material that differs from the polymeric material of the two housing members.

In various implementations and alternatives, the rotor seat may be configured as a rotor seat ring positioned in the second housing member at the discharge channel.

A rotary spray nozzle, in yet other implementations, may include a housing constructed of at least two housing members each formed of a polymeric material. A first housing member of the at least two housing members may include a coupler configured to couple with a second housing member of the at least two housing members, the second housing member may define an exterior surface of the housing, and each of the first housing member and the second housing member may define an internal surface, with the internal surfaces defining an internal chamber of the nozzle. An inlet member may be coupled to an inlet channel defined in the first housing member and be configured to deliver fluid to the internal chamber. A discharge channel may be defined in the second housing member and be configured to discharge the fluid from the nozzle. A rotor arranged within the internal chamber may include a rotor body defined by an inlet end, a contact portion and an outlet end, and the contact portion may be configured to frictionally engage a contact region of the internal chamber as the outlet end resides within a rotor seat of the second housing member at the discharge channel. The rotor body may include a rotor flow channel defined by a rotor inlet, a rotor lumen and a rotor outlet. As the fluid enters the inlet member and is discharged tangentially against a surface of the internal chamber, the fluid may cause the rotor to spin, and the contact portion and the contact region may provide frictional resistance to the rotor such that the fluid discharged from the rotor outlet assumes a generally continuous stream defining a circular spray pattern.

In various implementations and alternatives, the coupler may include a thread configured to engage in a threaded engagement with a thread of the second housing member. In such cases, a top cap may be coupled to the first housing member, which may reinforce the threaded engagement.

In various implementations and alternatives, the rotor may further include a rotor skirt surrounding a distal portion of the rotor body, where the fluid exerts force against the rotor skirt causing the outlet end of the rotor to be forced and seal against the rotor seat to cause the fluid discharged from the rotor outlet to be discharged from the discharge channel. In such cases, the rotor skirt may be at least partially received in a rotor skirt relief channel defined in a distal end of the internal chamber, and in some cases, the rotor skirt relief channel is defined concentrically around the discharge channel.

In various implementations and alternatives, a sleeve may be positioned against the internal chamber and defining the contact region. In some cases, the sleeve may be formed of a material that differs from the polymeric material of the at least two housing members.

In various implementations and alternatives, the rotor seat is configured as a rotor seat ring positioned in the second housing member at the discharge channel.

A rotary spray nozzle, in still other implementations, may include a housing constructed of at least two housing members each formed of a polymeric material, each of the at least two housing members defining an internal surface, the internal surfaces defining an internal chamber of the nozzle. An inlet member may be coupled to an inlet channel defined in a first housing member of the at least two housing members, the inlet member may be configured to deliver fluid to the internal chamber. A discharge channel may be defined in a second housing member of the at least two housing members, the discharge channel configured to discharge the fluid from the nozzle. A rotor may be arranged within the internal chamber, the rotor may include a rotor body defined by an inlet end, a contact portion and an outlet end. The contact portion may be configured to frictionally engage a contact region of the internal chamber as the outlet end resides within a rotor seat of the second housing member at the discharge channel. The rotor body may include a rotor flow channel defined by a rotor inlet, a rotor lumen and a rotor outlet, and a rotor skirt may surround a distal portion of the rotor body. As the fluid enters the inlet member and is discharged tangentially against a surface of the internal chamber, the fluid may cause the rotor to spin, the contact portion and the contact region may provide frictional resistance to the rotor, and the fluid may exert force against the rotor skirt causing the outlet end of the rotor to be forced and seal against the rotor seat such that the fluid discharged from the rotor outlet assumes a generally continuous stream defining a circular spray pattern and is caused to be discharged from the discharge channel.

In various implementations and alternatives, the rotor skirt may be at least partially received in a rotor skirt relief channel defined in a distal end of the internal chamber. In such cases, the rotor skirt relief channel may be defined concentrically around the discharge channel.

### BRIEF DESCRIPTION OF THE DRAWINGS

FIG. 1 is an isometric view of a first rotary spray nozzle, according to implementations of the present disclosure;

FIG. 2 is a cross-sectional view of the rotary spray nozzle of FIG. 1 taken at line 2-2 of FIG. 1;

FIG. 3 is a cross-sectional view of a variation of an internal chamber of the rotary spray nozzle of FIG. 2;

FIG. 4 is a cross-sectional view of the rotor of the rotary spray nozzle of FIG. 1 taken at line 2-2 of FIG. 1;

FIG. 5 is an exploded isometric view of the rotary spray nozzle of FIG. 1;

FIG. 6 is the cross-sectional view of the rotary spray nozzle of FIG. 2 illustrating a representative flow pattern within an internal chamber thereof;

FIG. 7 is an isometric view of a second rotary spray nozzle, according to implementations of the present disclosure;

FIG. 8 is a cross-sectional view of the rotary spray nozzle of FIG. 7 taken at line 8-8 of FIG. 7;

FIG. 9 is an exploded isometric view of the rotary spray nozzle of FIG. 7;

FIG. 10 is a plan, partially hidden view of the inlet member of FIG. 1, according to implementations of the present disclosure;

FIG. 11 shows detail of the cross-sectional view of the rotary spray nozzle of FIG. 2 taken at line 11-11 of FIG. 2 illustrating details of a rotor skirt and a rotor skirt relief channel, according to implementations of the present disclosure;

FIG. 12 is an isometric view of a third rotary spray nozzle, according to implementations of the present disclosure;

FIG. 13 is a cross-sectional view of the rotary spray nozzle of FIG. 12 taken at line 13-13 of FIG. 12;

FIGS. 14a-14d are front; top, left isometric; cross-sectional, and exploded views of the rotor of the rotary spray nozzle of FIG. 12;

FIGS. 15a-15b are cross-sectional and exploded views of a second rotor for use in the rotary spray nozzle of FIG. 12;

FIGS. 16a-16b are front and top, left isometric views of a third rotor for use in the rotary spray nozzle of FIG. 12;

FIGS. 17a-17b are bottom, right isometric and top, left isometric views of a fourth rotor for use in the rotary spray nozzle of FIG. 12;

FIG. 18 is an exploded view of the rotary spray nozzle of FIG. 12;

FIG. 19 is the cross-sectional view of the rotary spray nozzle of FIG. 13 illustrating a representative flow pattern within the internal chamber thereof; and

FIGS. 20a-20b are bottom, left isometric and cross-sectional views of the housing member of the rotary spray nozzle of FIG. 12.

FIG. 21 is an isometric view of a fourth rotary spray nozzle, according to implementations of the present disclosure;

FIG. 22 is a cross-sectional view of the rotary spray nozzle of FIG. 21 taken at line 22-22 of FIG. 21;

FIG. 23a is an isometric view of the rotor of the rotary spray nozzle of FIG. 21; and

FIG. 23b is a cross-sectional view of the rotor of FIG. 23a.

### DETAILED DESCRIPTION

Certain details are set forth below to provide a sufficient understanding of embodiments of the disclosure. It will be clear to persons skilled in the art, however, that embodiments of the disclosure may be practiced without various aspects of these particular details.

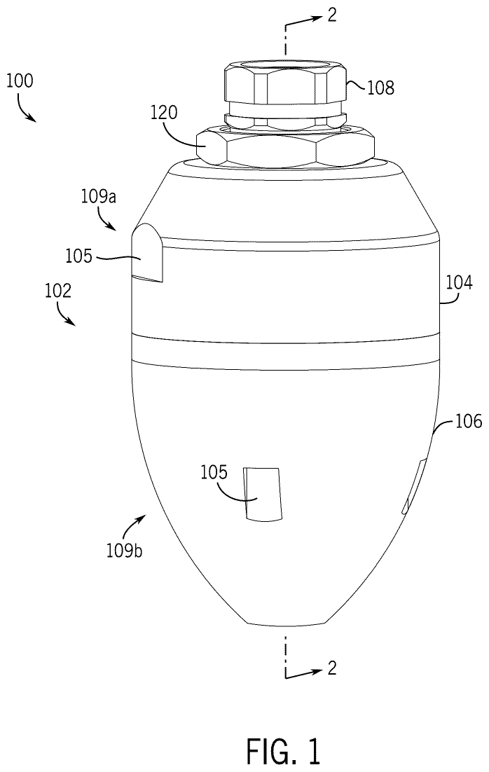

Referring to FIG. 1, a rotary spray nozzle 100 is provided, according to the present disclosure, for discharging fluid, e.g., water or other cleaning fluid, in generally continuous stream defining a circular spray pattern. The rotary spray nozzle 100 may include a housing 102 with at least two housing members: a first housing member 104 and a second housing member 106. The housing members 104, 106 may each be of a unitary construction formed as a single piece or member. Alternatively, the housing members 104, 106 may each be constructed of multiple components. The housing members 104, 106 may include one or more facets 105 such that housing members 104, 106 can be secured in a wrench or vice such as for assembly, dis-assembly, maintenance, inspection, assembly with other rotating assemblies, or the like. For instance, an inlet member 108 may be coupled to the first housing member 104 via a nut 120 using the facet 105 to secure the housing member 104 during coupling.

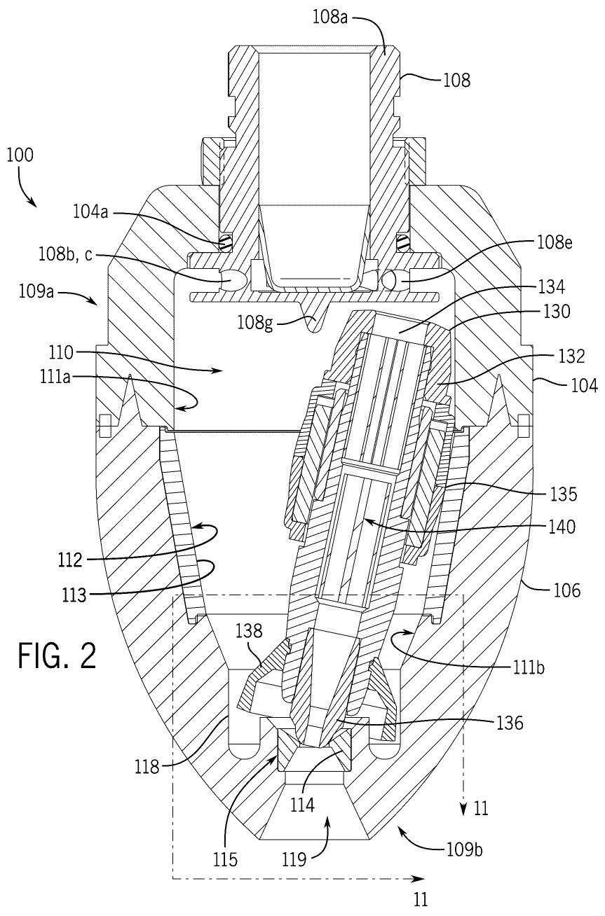

With reference to FIG. 2, the two housing members 104, 106 may, respectively, define external surfaces 109a, 109b of the housing 102 at an exterior of the nozzle 100, and respectively, define internal surfaces 111a, 111b of the housing 102. The internal surfaces 111a, 111b of the two housing members 104, 106 may define an internal chamber 110 of the nozzle 100 Upon their assembly, the housing components, e.g., first and second housing members 104, 106, may provide both at least a portion of the external surfaces 109a, 109b as well as the internal surfaces 111a, 111b of the housing 102.

According to certain embodiments of the present disclosure, the housing 102 may be constructed of a polymeric material, such as an injection molded or machined polymeric material, which may enable production of the nozzle 100 using two individual housing components, which may be configured to be joined to one another. The polymer materials provide the strength needed for the housing 102 to withstand high pressure spray applications that in prior approaches has required the use of a metal or metal alloy outer shell while at the same time, the polymer provides the ability to construct more complex flow geometries needed to define the internal chamber 110 of the nozzle 100. Accordingly, the disclosed implementations may be free of a metal or metal alloy outer shell. Polymer materials may include but are not limited to polyphenylene oxide (PPO), acetyl homopolymer (e.g., polyoxymethylene (POM) such as Delrin®) or combinations thereof. The polymer materials may also include reinforced composite polymers such as fiber-reinforced polymers. Reinforcing fibers and materials that may be incorporated into a polymer matrix include but are not limited to: glass fibers, carbon fibers, aramid (aromatic polyamide) and fibers thereof, ultra-high molecular weight polyethylene and fibers thereof, nylon and fibers thereof, and polypropylene and fibers thereof. Such reinforcing fibers and materials may be present in the polymer matrix. For instance, a glass-filled polymer includes glass fibers in a matrix of polymer material. In another example, reinforcing fibers or materials may be present in a matrix of polyphenylene oxide or acetyl homopolymer. In some implementations, the housing members 104, 106 may be formed of the same polymer, while in other implementations, may be formed of different polymers. For instance, the housing member 104 may be formed of a first polymer, while the housing member 106 may be formed of a second polymer such as a reinforced polymer. The polymers may enable the internal chamber 110 to withstand degradation for instance by being compatible with certain chemicals and/or with elevated temperatures and/or with low temperatures. In addition, the polymers may enable the internal chamber 110 to have specialized dimensions that may otherwise not be possible using machine or milling technologies. In some cases, metal components such as a metal shell or portions thereof may be provided by the housing 102.

In FIGS. 1 and 2, the first and second housing members 104, 106 define the external surfaces 109a, 109b of the nozzle 100, each of which may include surface features to facilitate installation of the nozzle 100 in spray applications, such as for fitting within a spray tower having receptacles with a shape and/or coupling members adapted to receive the nozzle 100. In some implementations, the external surface 109b of the second housing member 106 may taper towards the distal, discharge end of the nozzle 100 as shown in FIGS. 1 and 2.

The first housing member 104 may define the internal surface 111a contributing to the definition of a first portion of the internal chamber 110 of the nozzle 100, while the second housing member 106 may define the internal surface 111b contributing another portion of the internal chamber 110. The internal surfaces 111a, 111b may be configured to receive nozzle components such as the sleeve 113 and rotor 130 provided herein. In some implementations, the internal surface 111a of the first housing member 104 may include a cylinder shape from a proximal, inlet end towards a distal, outlet end of the nozzle 100. The internal surface 111b of the second housing member 106 may include both a tapering cone shape as the internal surface 111b transitions towards the distal end of the nozzle, and at a distal end of the second housing member 106, the internal surface 111b may define a cylinder shape with a narrower internal diameter compared to the cylinder shape of the internal surface 111a.

The first and second housing members 104, 106 may include complementary surface features for coupling to one another in a fluid-tight seal. For instance, the housing members 104, 106 may be non-detachably joined to one another by, for example, spin welding or adhesive bonding at the complementary surface features. Other examples of complementary surface features of the housing 102 may include detachable couplings as provided herein. In some implementations, seals such as O-rings may be positioned between the housing members as well as other components of the nozzle 100 (e.g., between the inlet member 108 and the first housing member 104) to facilitate providing the fluid-tight seal.

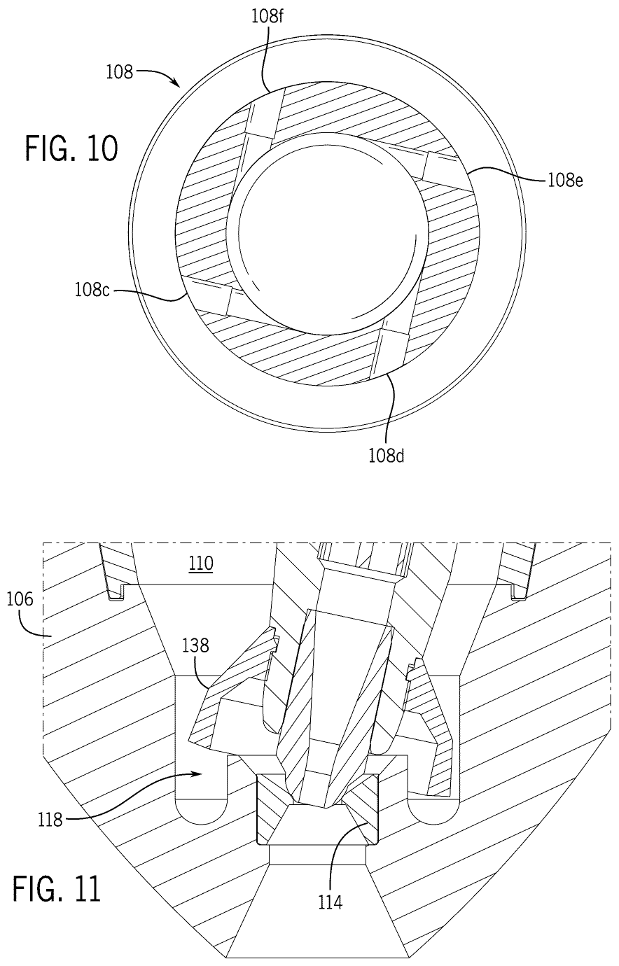

The inlet member 108 may generally define a fluid channel with a fluid ingress 108a and a fluid egress 108b. The first housing member 104 may receive the inlet member 108 via an inlet channel 104a defined in the first housing member 104. The fluid ingress 108a of the inlet member 108 may be configured to engage with a supply line, such as a water line for use in delivering water to spray applications, and accordingly the inlet member 108 may include threading or other connection types such as quick-connect fittings, bayonet fittings, snap fittings and so on for engagement with the supply line. The fluid egress 108b of the inlet member may be configured to deliver fluid to the internal chamber 110 of the nozzle 100. The fluid egress 108b may include a plurality of tangential discharge channels or through holes 108c, 108d, 108e, 108f (FIG. 10). The inlet member 108 may include a protrusion or surface feature 108g extending into the internal chamber 110, which may help guide the rotor 130 therein during a spraying operation. The inlet member 108 may include or be formed of a metal or metal alloy such as, for example, aluminum, brass, stainless steel and the like so as to provide necessary strength and durability when connecting to the supply line, which may deliver pressurized fluids such as pressurized water at high pressure.

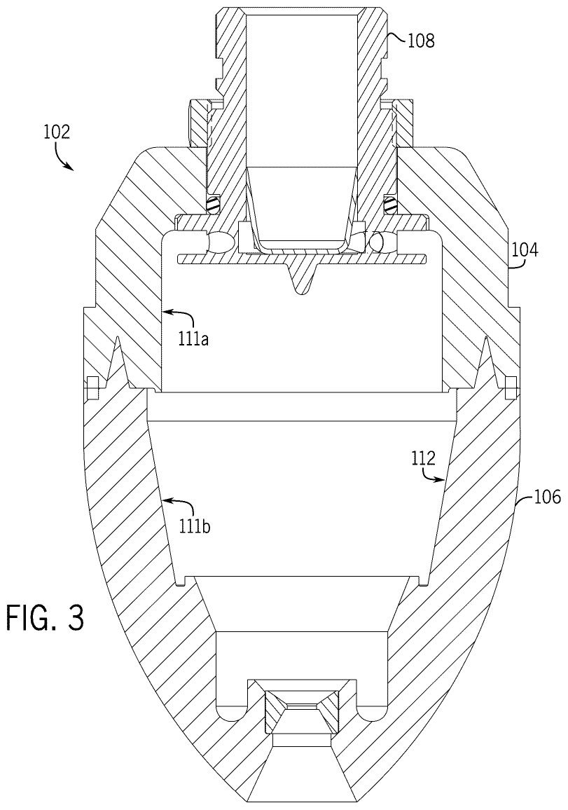

The internal chamber 110 may be defined by the housing 102 of the nozzle 100 and more particularly at least by the internal surfaces 111a, 111b of the respective first and second housing members 104, 106. In FIG. 2, the internal chamber 110 defines a contact region 112 for contacting the rotor 130 as described herein, an optional rotor seat ring 114, a rotor seat 115, a rotor skirt relief channel 118, and a discharge channel 119. The contact region 112 of the internal chamber 110 may be defined by a sleeve 113 arranged within the internal chamber as shown in FIG. 2, or may be defined by the internal surfaces 111a, 111b of the housing members 104, 106 as shown in FIG. 3. The internal chamber 110 may include the rotor seat 115 for receiving a distal end of the rotor 130 and may provide a through hole for fluid exiting the nozzle 100. The rotor seat 115 may be defined by the internal surface 111b of the second housing member 106 and/or may be provided by a rotor seat ring 114. The internal chamber may define a rotor skirt relief channel 118 at a distal end of the internal surface 111b of the second housing member 106. The rotor skirt relief channel 118 may be configured as a ring-shaped channel and may have an external diameter that is larger than an external diameter of a rotor skirt 138 of the rotor 130 as provided herein. An internal diameter of the rotor skirt relief channel 118 may be concentric with the discharge channel 119 defined in the second housing member 106 of the nozzle 100. The internal chamber 110 may be configured to house nozzle components such as the fluid egress 108b portion of the inlet member 108, the sleeve 113 when present, the rotor seat ring 114 when present, and the rotor 130.

The sleeve 113 when present in the internal chamber 110 may be formed of an elastomeric material and may provide at least a portion of the contact region 112 for contacting the rotor 130. In some implementations, the sleeve 113 may be constructed of a material that differs from the material of the housing 102. For instance, the sleeve material may be selected to control a level of frictional engagement with the rotor 130 and may be formed of an elastomer. Exemplary sleeve 113 materials may include but are not limited to ethylene propylene diene monomer (EDPM), acrylonitrile butadiene rubber (e.g., Buna-N), brass, or acetyl homopolymer (e.g., polyoxymethylene (POM) such as Delrin®). The sleeve 113 may be mounted in the internal chamber 110, and for instance may be press fit into a receiving region defined in the internal chamber 110.

The rotor seat ring 114 when present in the internal chamber may be formed of a material configured for contacting a distal end of the rotor 130. In some implementations, the rotor seat ring 114 may be constructed of a material that differs from the reinforced polymeric material of the housing 102. For instance, the rotor seat 115 material may be selected to control a level of frictional engagement with the distal end of the rotor 130, e.g., to reduce friction relative to the housing 102, and/or may be selected to increase durability. Exemplary rotor seat ring 114 materials may include but are not limited to tungsten carbide, ceramic, and combinations. The rotor seat ring 114 may be fitted, e.g., press fit or threaded, into a receiving portion defined by a distal end of the internal chamber 110.

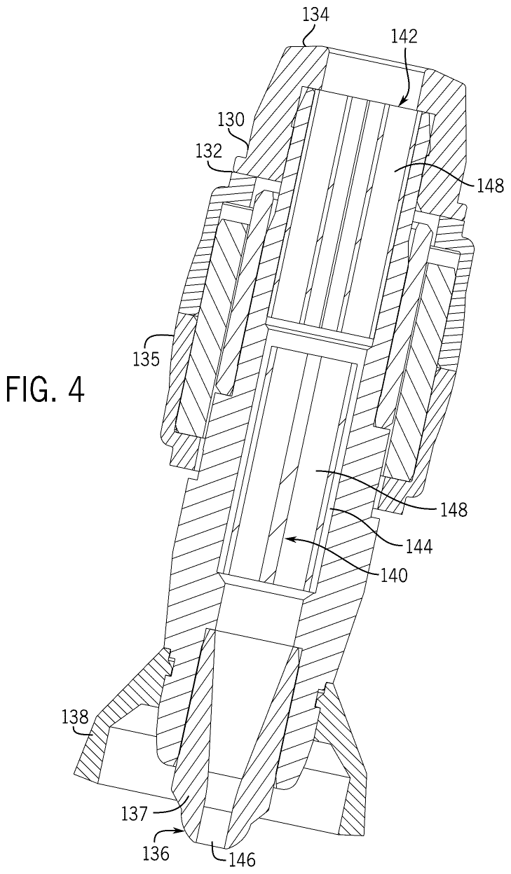

The rotor 130 may be configured to be rotatably arranged within the internal chamber 110 of the nozzle 100. The rotor 130 may include a rotor body 132 with an inlet end 134, a contact portion 135, an outlet end 136 with a nozzle tip 137, a rotor skirt 138, and a flow channel 140 extending along a longitudinal axis of the rotor 130. The contact portion 135 at an exterior of the rotor 130 may be configured to frictionally engage the contact region 112 of the internal chamber 110 as the outlet end 136 resides within the rotor seat 115, e.g., of the second housing member 106 or the rotor seat ring 114. Exemplary contact portion 135 materials may include but are not limited to brass, polypropylene, acetyl homopolymer (e.g., polyoxymethylene (POM) such as Delrin®), fluoropolymer resin coatings such as polyvinylidene difluoride plastic (e.g., Kynar®), and combinations. The nozzle tip 137 may be arranged in the flow channel 140 at the outlet end 136 and may serve as a fluid egress for the rotor 130. The nozzle tip 137 may include a fluid channel with a tapered configuration narrowing towards the outlet, and an external surface of the nozzle tip 137 may contact and form a fluid seal with the rotor seat 115 or rotor seat ring 114, as provided herein. A rotor skirt 138 surrounds a distal portion of the rotor 130 around the longitudinal axis thereof and is configured to engage in the rotor skirt relief channel 118 of the internal chamber 110. The rotor skirt 138 may be constructed of an injection molded or machined polymeric material as described herein. For transmitting fluid, the rotor body 132 includes a rotor flow channel 140 defined by a rotor inlet 142, a rotor lumen 144 and a rotor outlet 146 (FIG. 4). The rotor inlet 142 may be arranged at an opening of the flow channel 140, and for instance, fluid moving axially relative to the rotor axis may flow directly into the flow channel 140. The rotor lumen 144 may include one or more flow straighteners 148 to facilitate movement of the fluid through the rotor 130. Changing a number of lumens of a given flow straightener 148 may alter spray characteristics of the fluid. The lumens or tubes may have the same cross-section and length across sections, or may differ. For instance, a first flow straightener 148 may include a section of seven lumens or tubes, while a second flow straightener 148 may include a section of three lumens or tubes. Progressively reducing the number of tubes or lumens in a sequence of flow straighteners may further promote a laminar flow of fluid from the rotor body 132.

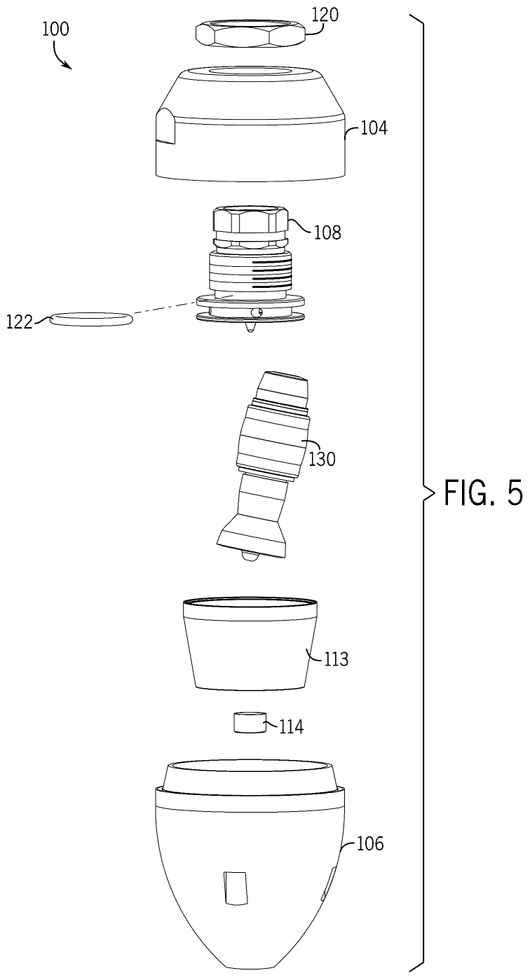

FIG. 5 shows an exploded isometric view of the nozzle 100. Assembly of the nozzle 100 may involve inserting the rotor 130 into the housing, optionally inserting the sleeve 113 into the second housing member 106, optionally inserting the rotor seat ring 114 into the second housing member 106, coupling sealing components between the first housing member 104 and the inlet member 108, such as a sealing ring 122, attaching a nut 120 to an external surface of the inlet member 108 to secure the inlet member to the first housing member 104, and attaching the housing members 104, 106 to each other, for instance, by spin welding or by adhesive bonding such that the housing members are non-detachably joined to one another.

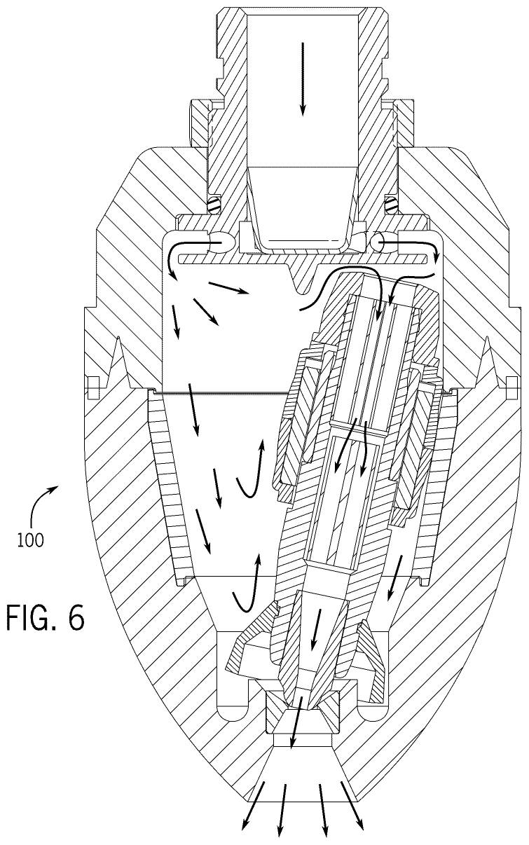

In FIG. 6, the nozzle 100 functions to deliver fluid from the discharge channel 119 during a spraying operation by receiving the fluid at the inlet member 108 from the supply line. The fluid is directed through the fluid channel of the inlet member 108 and travels to the fluid egress 108b of the inlet member 108 where it enters the plurality of tangential discharge channels or through holes 108c, 108d, 108e, 108f (FIG. 10) resulting in the fluid being tangentially delivered to the internal chamber 110 of the nozzle 100. The fluid is directed against the surfaces 111a, 111b of the internal chamber 110, causing the rotor 130 to spin within the internal chamber 110 against the rotor seat 115. Upon contacting the rotor body 132, fluid enters the inlet end 134 via the flow channel 140 and passes through the rotor inlet 142, rotor lumen 144 and finally exits the rotor outlet 146 (FIG. 4). Due to rotation of the rotor 130, the fluid exiting the rotor outlet 146 is in a substantially circular pattern. As the rotor 130 spins, the contact portion 135 of rotor 130 engages the contact region 112 of the internal chamber generating friction to slow the spinning velocity of the rotor 130 such that the fluid exiting the rotor outlet 146 maintains a substantially continuous stream. While in the internal chamber 110, the fluid forces the rotor skirt 138 of the rotor 130 in a distal or angled distal direction resulting in forcing the outlet end 136 of the rotor 130 against the rotor seat 115, which may create a fluid-tight seal. The rotor skirt relief channel 118 of the internal chamber 110 provides relief to the rotor skirt 138 enabling the rotor skirt 138 to move and rotate within the internal chamber 110, while forcing the outlet end 136 of the rotor 130 against the rotor seat 115. As a result of the force exerted on the rotor skirt 138, the rotor outlet 146 is forced and seals against the rotor seat 115 to cause the fluid to exit the nozzle 100 through the discharge channel 119. Inclusion of the rotor skirt 138 may facilitate creation of the fluid-tight seal between the rotor 130 and the rotor seat 115 of the housing to prevent fluid from bypassing the rotor 130 and escaping the nozzle 100 before passage through the rotor outlet 146 (e.g., blow-by may be prevented), particularly at lower operational pressures compared to similar nozzles without the rotor skirt. Further, the rotor skirt 138 may shield and prevent fluid from reaching the discharge channel 119 of the nozzle 100 (e.g., preventing blow-by) such that the fluid moves within the internal chamber 100 and reaches the rotor inlet 142 for its eventual discharge through channel 119.

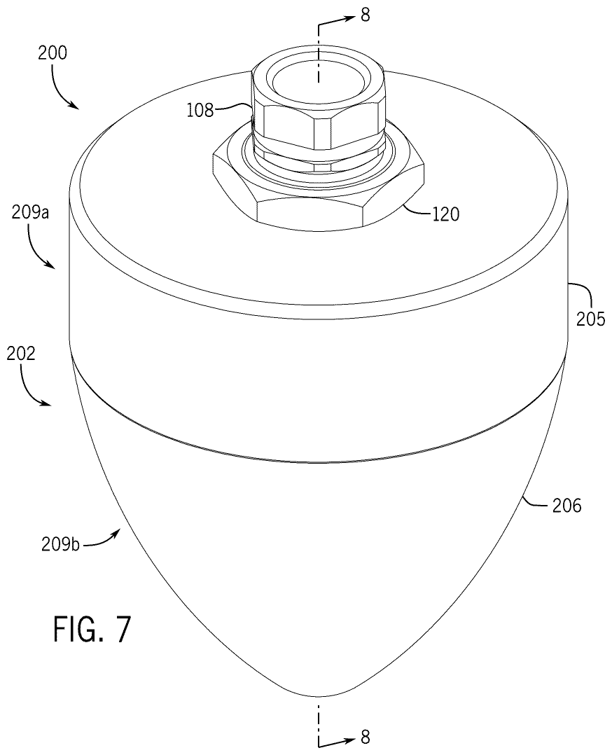

Referring to FIGS. 7 to 9, various views of a rotary spray nozzle 200 are illustrated, according to implementations of the disclosure. The nozzle 200 may include elements that have been previously described with respect to the nozzle 100 of FIGS. 1-6 and 10. Those elements have been identified in FIGS. 7 to 9 using the same reference numbers used in FIGS. 1-6 and 10 and operation of the common elements is as previously described. Consequently, a detailed description of the operation of these particular elements will not be repeated in the interest of brevity.

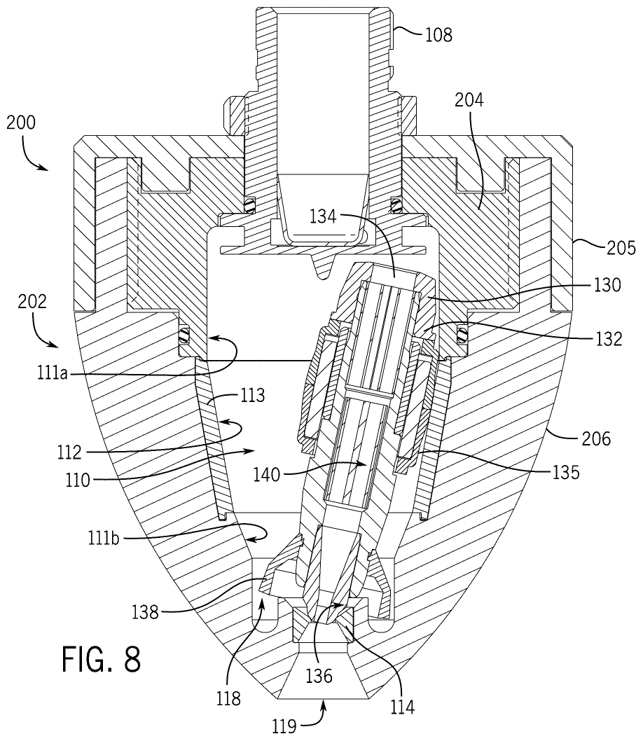

Referring to FIGS. 7 and 8, a rotary spray nozzle 200 according to implementations of the present disclosure includes a housing 202 with at least two housing members, including a first housing member 204 and a second housing member 206. A top cap 205 may cover at least a portion of the first housing member 204. Similar to the nozzle 100, the first and second housing members 204, 206 of nozzle 200 may each be of a unitary construction formed as a single piece or member. The top cap 205 may be formed as a unitary component, or may be formed integrally with the first housing member 204. When formed separately, the two may be joined for instance between a threaded nut 120 and a flange of an inlet member 108 as shown in FIG. 8.

Similar to the nozzle 100, the housing 202 of the nozzle 200 may be constructed of a reinforced polymeric material, such as an injection molded or machined reinforced polymeric material as disclosed herein. In contrast to the nozzle 100, the external surfaces 209a, 209b of the housing 202 may be defined by the top cap 205 and by the second housing member 206 of nozzle 200. Inclusion of the top cap 205 with the nozzle 200 may facilitate retention of a releasable engagement between the housing members 204, 206 as provided herein. As an alternative to a top cap 205, a collar may be provided to facilitate the releasable engagement. Similar to nozzle 100, the first and second housing members 204, 206 of the nozzle 200 may define internal surfaces 111a, 111b that define the internal chamber 110 of the nozzle 200. The internal chamber 110 and its components (e.g., internal surfaces 111a, 111b, optional sleeve 113, rotor 130, etc.) of the nozzle 200 and the internal chamber 110 and its components of nozzle 100 share the same configuration, and therefore the details of the internal chamber 110 of the nozzle 200 are not repeated.

The top cap 205 may be constructed of a polymer such as a reinforced polymer, which may be the same or different from the reinforced polymer forming the first and second housing members 204, 206. For instance, where the top cap 205 and the first housing member 204 are integrally formed, the entire structure may be formed of a reinforced polymer. Alternatively, where the top cap 205 is formed separately, the top cap may be formed of a polymer material that, for instance, facilitates retention of a coupling between the first and second housing members 204, 206. Exemplary top cap 205 or collar materials may include but are not limited to polyphenylene oxide (PPO).

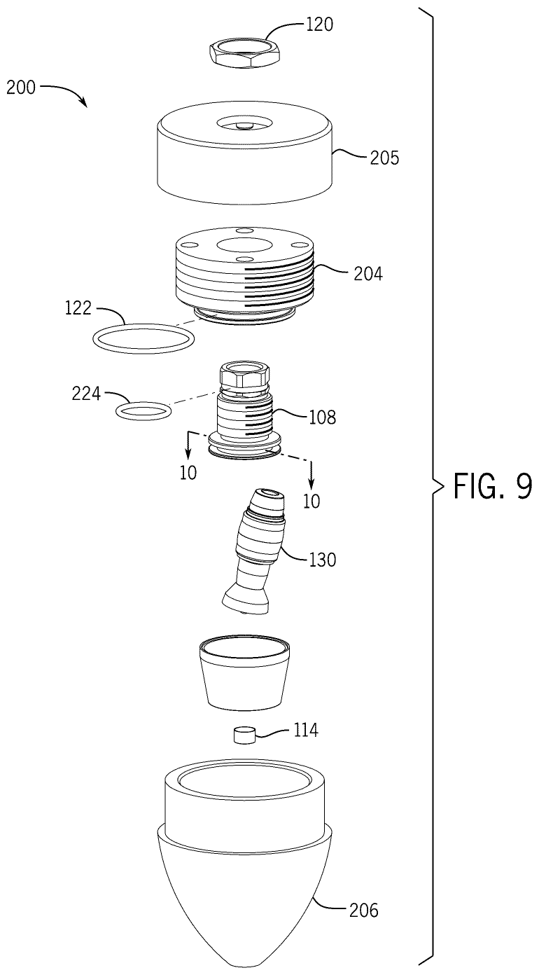

FIG. 9 shows an exploded isometric view of the nozzle 200. Assembly of the nozzle 200 may involve inserting the rotor 130 into the first or second housing member 204, 206, optionally inserting a sleeve into the second housing member 206, optionally inserting the rotor seat ring 114 into the second housing member 206, coupling sealing components between the first housing member 204 and the inlet member 108, such as a sealing ring 122, coupling sealing components between the first housing member 204 and the second housing member 206, such as a sealing ring 224, attaching a nut 120 to an external surface of the inlet member 108 to secure the nut 120, the inlet member 108, the top cap 205, and the first housing member 204 to each other, and attaching the housing members 104, 106 to each other, for instance, by establishing a threaded engagement. Accordingly, the first and second housing members 204, 206 of nozzle 200 may include respective threads for establishing a releasable threaded engagement. For instance, with reference to FIG. 9, the first housing member 204 may carry a coupler such as an external thread configured to receive an internal thread of the second housing member 206. Alternatively, the first housing member 204 may carry an internal thread for receiving an external thread of the second housing member 206. Other fastening mechanisms are within the scope of the present disclosure and may include but are not limited to bayonet connections, spring clip connections, quick connect fittings, and so on.

During a spraying operation, the nozzle 200 functions similar to nozzle 100 described in connection with FIG. 6 and is therefore not repeated herein. In addition, the top cap 205 or collar may facilitate retention of the coupling between the first and second housing members 204, 206 by exerting force radial inwardly as the force of the fluid within the internal chamber 110 forces the housing members 204, 206 radially outwardly. This reinforcement or support exerted may prevent the housing members 204, 206 from detaching, e.g., unthreading in the case of a threaded engagement. Due to the first and second housing members 204, 206 being detachably connected, in some implementations, after periods of extended use, components of the nozzle 200 may be removed and replaced. For instance, the rotor 130, one or both of the housing members 204, 206, and/or the top cap 205 may be removed and replaced. In addition or alternatively, replacement components of the nozzle 200 may have a configuration that differs from the original components. For instance, the surfaces 111a, 111b of the internal chamber 110 may have varying configurations for replacement housing members 204, 206. In one example, the contact region 112 of the internal chamber 110 may have a different configuration to change friction characteristics between the contact region 112 and the contact portion 135 of the rotor 130. In addition or alternatively, a replacement rotor 130 may have a contact portion 135 with differing frictional characteristics from an original rotor 130. The ability to select various components for use in the nozzle 200 may enable users to select nozzle features for a desired spray, based on a target application.

Referring to FIG. 11, a detailed view of the second housing member 106 of the nozzle 100 is illustrated; however it will be appreciated that following description also applies to the other nozzles disclosed herein due to common components shared between them. During a spraying operation, fluid within the internal chamber 110 exerts force on an outer portion of the rotor skirt 138, and due to the rotor skirt 138 being rigidly attached to the rotor 130, the force exerted causes the outlet end 136 of the rotor 130 to be forced against the rotor seat 115, e.g., against the rotor seat ring 114, to provide a seal, while the rotor 130 simultaneously rotates under the pressure of the fluid. The configuration of the rotor 130 and its rotor skirt 138 enables the rotor outlet 146 to discharge fluid directly through the discharge channel 119 of the nozzle 100 resulting in the rotating rotor 130 discharging fluid from the rotor outlet 146 that assumes a generally continuous stream defining a circular spray pattern, while simultaneously being discharged from the discharge channel 119 of the nozzle 100 rather than into the internal chamber 110, to thereby provide an efficient spraying operation. For instance, the circular spray pattern may generate a cone, which may be delivered in a wide range of angles from about 1 to about 45 degrees. As illustrated, to permit the rotor skirt 138 and thus rotor 130 to rotate within the internal chamber, the internal chamber 110 provides the rotor skirt relief channel 118 having a dimension that permits the rotor skirt 138 to move and for instance rock into and out of the channel 118. For instance, the rotor skirt relief channel 118 may have a cylindrical shape and terminate in a rounded trough at a distal end of the second housing member 106. The channel 118 may have a depth and a rounded profile to prevent the rotor skirt 138 from sticking or lodging therein.

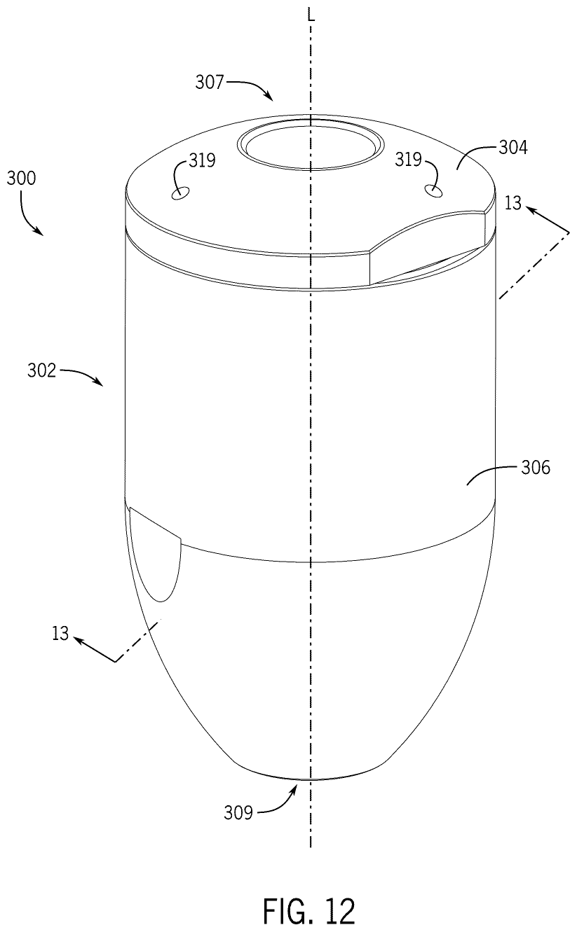

Referring to FIGS. 12 to 20b, illustrated is another embodiment of a rotary spray nozzle 300, according to implementations of the disclosure. The nozzle 300 may include elements that have been previously described with respect to the nozzles 100 and 200 of FIGS. 1-11. Various elements have been shown and/or identified in FIGS. 12 to 20b using the same reference numbers used in FIGS. 1-11, and operation of the common elements is as previously described. Consequently, a detailed description of the operation of these particular elements will not be repeated in the interest of brevity.

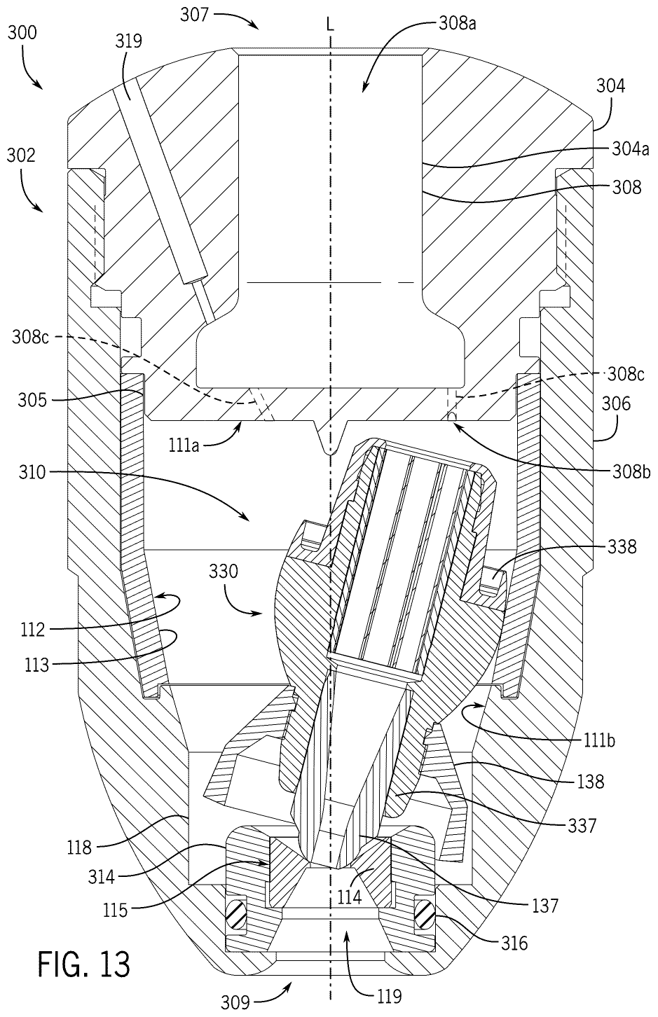

In FIG. 12, the rotary spray nozzle 300 may include a housing 302 with a first housing member 304 and a second housing member 306. An inlet end 307 may receive and/or define an inlet member, e.g., 108 and/or 308. An outlet end 309 may define the discharge channel 119 (FIG. 13). In FIG. 12, rear discharge channels 319 may be defined in the first housing member 304 and disposed about the inlet end 307 and fluidly coupled to the inlet member 308.

FIG. 13 shows a cross-sectional view of the rotary spray nozzle 300 including the housing 302 and internal chamber 310 containing a rotor 330. The first housing member 304 may define at least a portion of the inlet member 308 and may be configured as a cap or an insert for receipt by the second housing member 306. The inlet member 308 portion of the first housing member 304 may generally define a fluid channel with a fluid ingress 308a and a fluid egress 308b, and differs from nozzles 100, 200 in that the fluid egress 308b may define a plurality of angled discharge channels or through holes 308c that discharge fluid directly into the internal chamber 310 via the top wall of the internal chamber 310, e.g., via the internal surface 111a of the first housing member 304 as shown in FIG. 13, rather than through tangential discharge channels. The angled discharge channels 308c may extend between a bottom or distal surface of an inlet channel 304a and a proximal surface or the top wall of the internal chamber 310 and may be oriented at an angle offset from a longitudinal axis L of the housing 302 such that the fluid is delivered from the fluid egress 308b at an angle into the internal chamber 310. The angle of discharge may be selected to facilitate operation of the rotor 330 as provided herein. For instance, the discharge channels or through holes 308c may enable fluid to be discharged to the internal chamber 310 an angle of about 15 to 45 degrees offset from the longitudinal axis, such as about 20, 25, 30, 35 or 40 degrees.

The internal chamber 310 of the rotary spray nozzle 300 may be generally defined by the internal surfaces 111a, 111b the housing members 304, 306 and may be relatively smaller compared to the internal chamber 110 of the rotary spray nozzles 100, 200. In FIG. 13, the internal surface 111a of the first housing member 304 defines a top wall of the internal chamber 310, while the internal surface 111b of the second housing member 306 may define the remainder. An interior projection 305 of the first housing member 304 may be seated against the sleeve 113 when arranged in the internal chamber 310, and may form a seal therewith. In addition to the internal chamber components described in connection with rotary spray nozzles 100 and 200, the internal chamber 310 may additionally include a seat retainer 314 configured to receive the rotor seat ring 114 and may define a portion of the rotor skirt relief channel 118. The seat retainer 314 may be seated against the second housing member 306 and a seal may be formed therebetween using a seal 316 such as an O-ring.

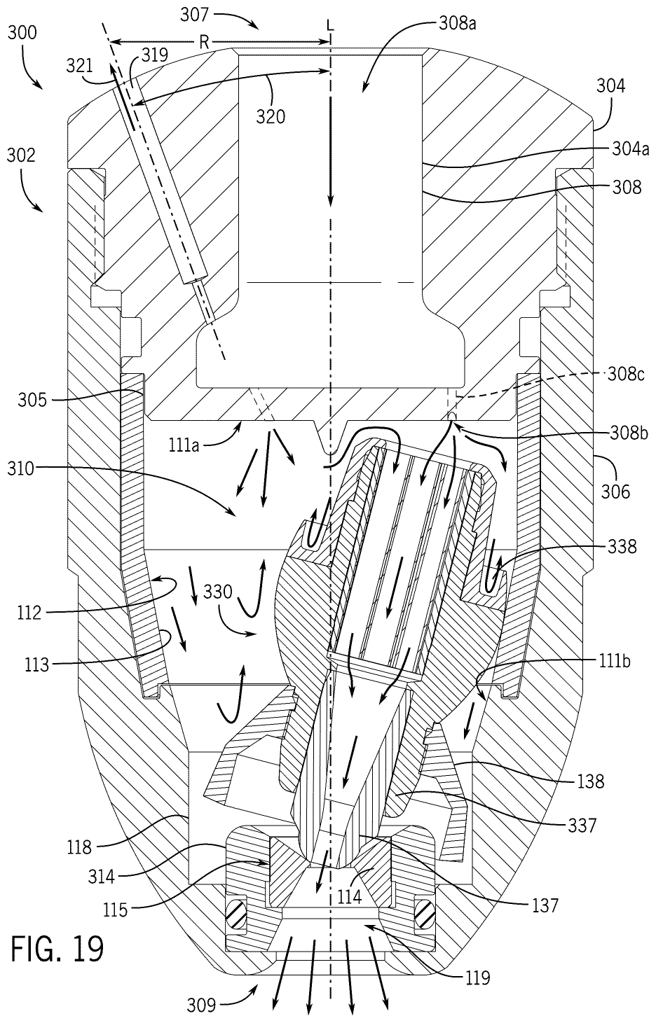

The rear discharge channels 319 of the rotary spray nozzle 300 may be generally defined by the housing 302 such as the first housing member 304 and be fluidly connected to the inlet member 308, and may be disposed at an angle 320 with respect to the longitudinal axis L around the inlet member 308 (see FIGS. 13 and 19). Thus, a portion of the fluid delivered to the nozzle assembly 300 may flow from the inlet member 308 and into the rear discharge channels 319.

The rotor 330 may be configured to be rotatably arranged within the internal chamber 310 of the nozzle 300.

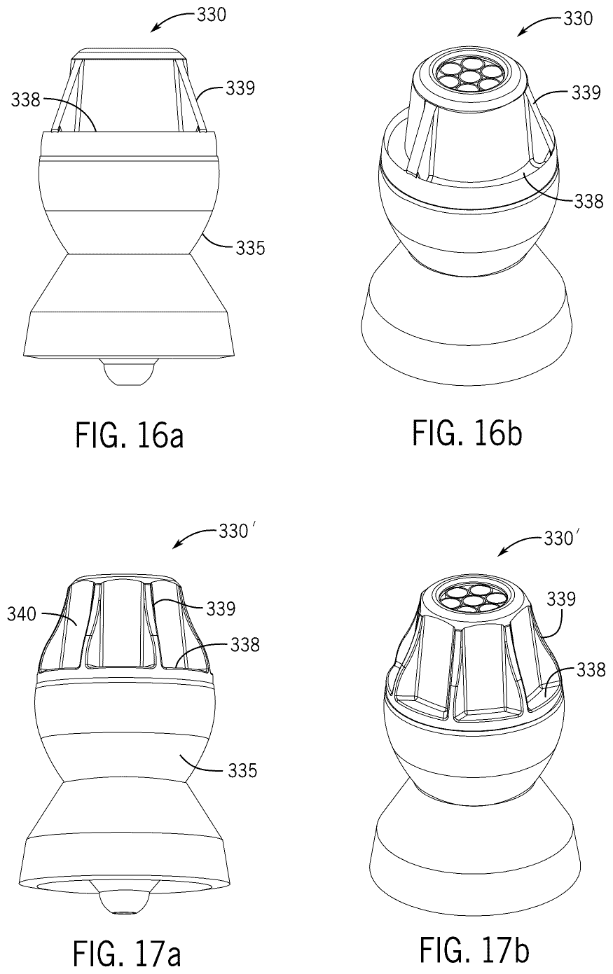

With reference to FIGS. 13 and 14a-16b, the rotor 330 differs from the rotor 130 of the nozzles 100, 200 in that the rotor 330 of the rotary spray nozzle 300 may include a spherical region 335, an external channel 338, one or more external flanges 339 (e.g., FIGS. 16a-16b), and a single set of flow straighteners 148 as provided herein.

The rotor 330 may generally include a rotor body 331 with an inlet end 134, a contact portion 135, an outlet end 136 with a nozzle tip 137, a rotor skirt 138, and a flow channel 140 extending along a longitudinal axis of the rotor 130. These elements and their related components have been previously described with respect to the nozzles 100 and 200 using the same reference numbers and operation of the common elements is as previously described and not be repeated in the interest of brevity. The rotor may be constructed of materials such as metal, polymers, composites and so on.

The rotor body 331 of the rotor 330 may include a first portion 332 proximate an inlet of the rotor body 330, a second or middle portion 334, and a third portion 336 proximate the outlet of the rotor body, each sharing a common longitudinal axis with the rotor body 331. The portions 332, 334 and 336 may extend axially and each may account for about ⅛ to about ⅞ of a length of the rotor body 331, such as about ⅓ or ½. The portions 332, 334, 336 may be configured as a conical, cylindrical and/or spherical regions. In addition, the portions 332, 334, 336 may be separate components, may be integrally formed, and combinations.

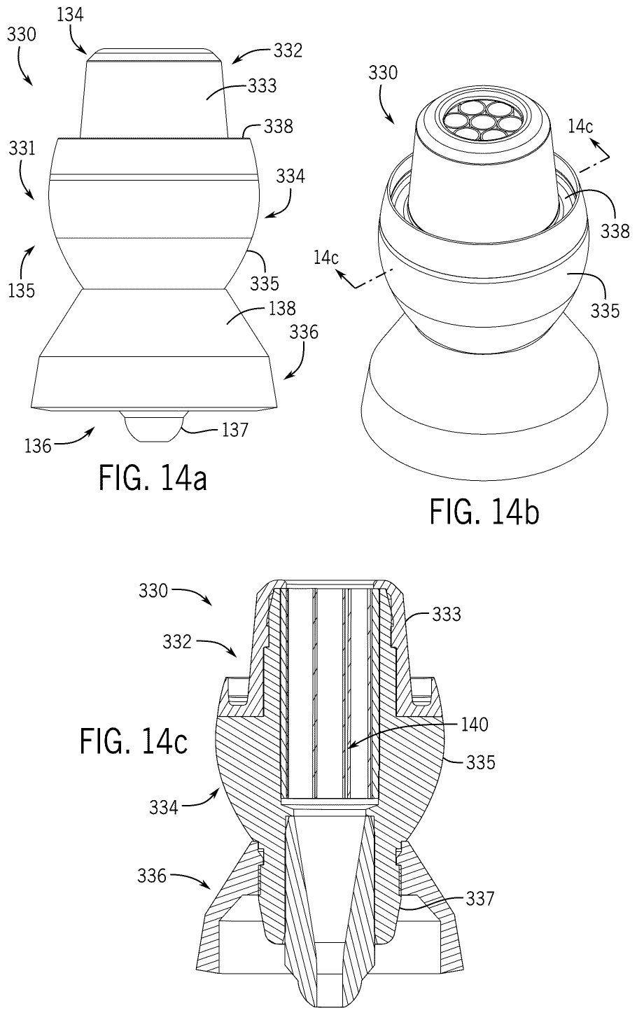

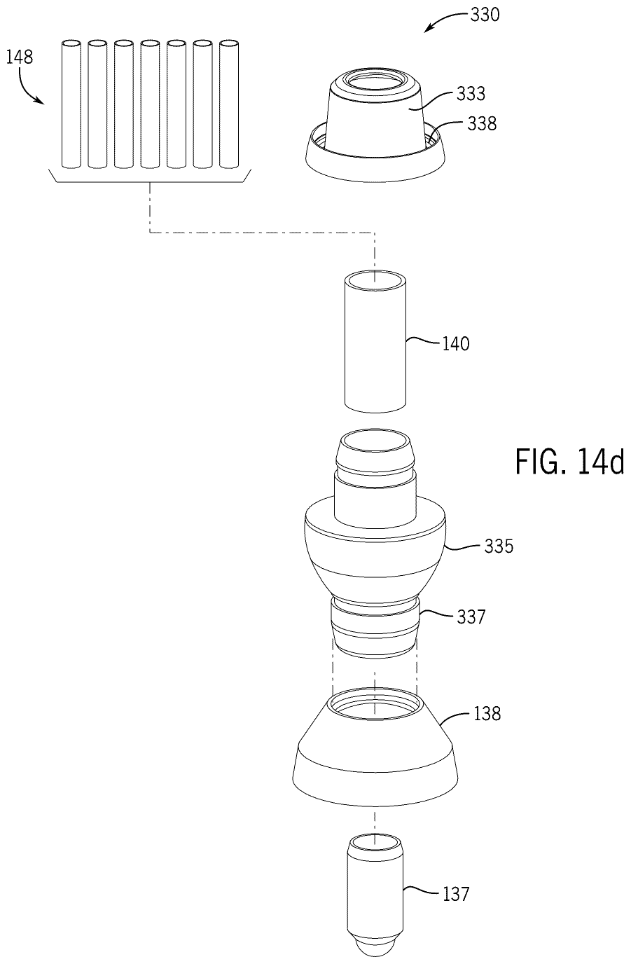

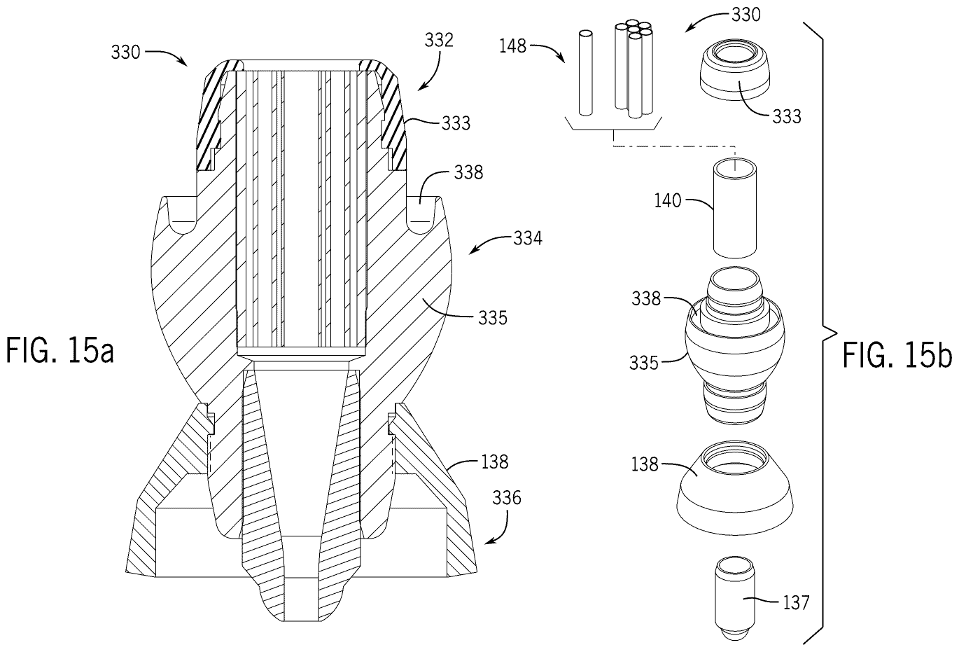

With reference to FIG. 14a a front view of the rotor 330 is illustrated in which a cylindrical or conical portion 333 of the rotor body 331 may be provided at a proximal, inlet end 134 of the rotor 330. In some implementations, the cylindrical or conical portion 333 may be defined by the first portion 332 of the rotor body 331, which may be a separate component from one or more of the other portions 334, 336 for instance as shown in the cross-sectional view of the rotor 330 of FIGS. 14c and 15a. For instance, the cylindrical or conical portion 333 may be formed of an injection molded or machined polymeric material, while other components of the rotor body 331 may be separately injection molded or machined and may be formed of the same or different materials as the cylindrical or conical portion 333. Alternatively, the cylindrical or conical portion 333 may be integrally formed with other components of the rotor body 331.

The spherical region 335 of the rotor body 331 may be provided as a central portion of a sphere with end caps being replaced, e.g., replaced with the conical portion 333 at a proximal end and the rotor skirt 138 at a distal end. For instance, the spherical region 335 may be a central portion of a sphere may include about ½ to ⅔ of the height of a total sphere, with end caps on opposing sides removed and replaced by other components of the rotor body 331. In some examples, the spherical region 335 may be defined by two or three portions 332, 334, 336 of the rotor body 331. For example, the spherical region 335 may be defined by the second portion 334 of the rotor body 331, which may be a separate component from one or more of the other portions 332, 336 for instance as shown in the cross-sectional view of the rotor 330 of FIG. 14c. Alternatively, the spherical region 335 may be integrally formed by the rotor body 331. The spherical region 335 of the rotor body 331 may also define or form a part of the contact portion 135 of the rotor 330. The spherical region 335 may be constructed or formed of the various materials disclosed herein, such as from a polymer, a composite material, a metal and/or metal alloy such as, for example, aluminum, brass, stainless steel and the like so as to provide necessary weight and durability when contacting the internal chamber in a high fluid pressure environment. Constructing all or a portion of the spherical region 335 using a heavier material (e.g., a metal and/or metal alloy) compared to other materials (e.g., polymer and/or composite material) forming remaining portions of the rotor body 331 may provide the rotor 330 with a centralized center of gravity and may facilitate rotation and positioning of the rotor 330 in the rotor seat 115 during a spraying operation.

A cylindrical or conical portion 337 of the rotor body 331 may be provided at a distal, outlet end 136 of the rotor 330. The cylindrical or conical portion 337 may generally receive the nozzle tip 137. In some implementations, the cylindrical or conical portion 337 may be provided by the third portion 336 of the rotor body 331, and for instance as shown in the cross-sectional view of the rotor 330 of FIG. 14c, the second and third portions 334, 336 of the rotor body 331 may be integrally formed.

The external channel 338 of the rotor body 331 may extend concentrically around all or at least a portion of an external circumference of the rotor body 331. The external channel 338 may be arranged transverse to the longitudinal axis L of the rotor body 331. As shown in FIGS. 14b and 14c, the external channel 338 may be formed with a cup-shape or trough and may be positioned for instance at a transition between the first and second portions 332, 334 of the rotor 330 (FIG. 14a). The cup-shape of the external channel 338 (e.g., u-shape or trough-shape) may have an open end facing the inlet end 134 of the rotor body 331 and a concave portion or closed end directed towards the outlet end 136 of the rotor 330, and a downward extension of the external channel 338 may extend parallel to the longitudinal axis L of the rotor body 331. An outer edge of the external channel 338 may define a lateral exterior sidewall of the rotor body 331 and may serve as part of the contact portion 135. An inner edge of the external channel 338 may join with a medial external sidewall of the rotor body 331 such as at a distal end of the first portion 332, for instance as shown in FIGS. 14c and 14d, resulting in the external channel 338 and associated sidewalls forming a j- or hook-shape with other portions of the external sidewall of the rotor body 331. In some cases, the external channel 338 may be integrally formed with the cylindrical or conical portion 333 for instance as shown in FIGS. 14a-14d. Alternatively, the external channel 338 may be integrally formed with the spherical region 335 of the rotor body 331 for instance as shown in FIGS. 15a-15b. The external channel 338 may function to receive fluid from the fluid inlet 108, e.g., via the angled discharge channels or through holes 308c, such that some of the fluid in the internal chamber 110 is briefly retained in the external channel 338 and then flows back into the internal chamber 110. Due to the fluid being delivered at high pressures, the force of the fluid entering the external channel 338 forces the nozzle tip 137 at the outlet end 136 of the rotor 330 into the rotor seat 115 to facilitate forming a fluid tight seal therebetween. Accordingly, the external channel 338 and the flow channel 140 may not be fluidly coupled, but rather fluid exiting the external channel 338 may eventually be directed into the flow channel 140 and exit the nozzle 300. The external channel 338 may be constructed or formed of various materials including those of the present disclosure including polymers, composite materials, metals and/or metal alloys and may be injection molded or machined to impart durability to the external channel 338 when contacted by the high pressure fluid in the internal chamber 310.

With reference to FIGS. 16a-17b, the one or more external flanges 339 of the rotor 330 may optionally extend along a length of the rotor body 331 from the inlet end 134 to the external channel 338. As shown in FIGS. 16a-16b, the external flanges 339 may gradually widen as they extend distally, and at a distal end may have a width corresponding to a distance between the medial wall of the conical portion 333 and an outer lateral edge of the external channel 338. The flanges may facilitate rotation of the rotor, e.g., initiating and/or maintaining rotation, and may add strength to the rotor body 331 or portions thereof. The flanges 339 may be spaced around a circumference of the rotor such as about every 90° or 120° as shown in FIGS. 16a-16b. Other flange configurations are also possible, and for example seven flanges 139 may be spaced around the rotor such as about every 50° as shown in FIGS. 17a-17b. The rotor body may include 1, 2, 3, 4, 5, 6, 7, 8, 9, 10, 12, 14, 16, 18, 20, 24, or 30 flanges 139, or any range therebetween. In addition, a portion of the lateral edges of the flanges 339 may be rounded and may define a portion of the spherical region 335 of the rotor body 331 as shown in FIG. 17a-17b. In the example rotor 330′ shown in FIGS. 17a-17b, the area between the flanges 339 may define grooves 340 of the rotor body 331, and the grooves 340 may also function to receive the pressurized fluid and direct the fluid into the external channel 338, which may force the nozzle tip 137 of the rotor 330 into the rotor seat 115 to facilitate forming a fluid tight seal therebetween. The grooves 340 may define a planar sidewall along the conical portion 333 of the rotor body 331, which may provide a polygon-type shape to the conical portion 333, e.g., triangle, pentagon, hexagon, heptagon, octagon, and so on, depending on the number of grooves 340.

The rotor skirt 138 may be coupled to the rotor body 331, and as shown in FIGS. 14a-17b, may be coupled to a distal end of the rotor 330. For instance, the rotor skirt 138 may encircle the rotor body 331 at a distal end of the spherical region 335. The rotor skirt 138 may be arranged around any of the various portions 332, 334, 336 of the rotor body 331, and is shown as encircling the third portion 336. The rotor skirt 138 may define a cone or conical region that extends radially from the rotor body 331 and widens towards a distal end of the rotor 330. The rotor skirt 138 may transition to another cone shape with a reduced degree of widening, or to a cylindrical sleeve-shape before terminating as the rotor skirt 138 approaches the outlet of the rotor body 331. The rotor skirt 138 may be non-detachably coupled to or integrally formed with the rotor body 331 and may share a common rotational and longitudinal axis L with the rotor body 331.

The rotor 330 may include a single set of flow straighteners 148 within the flow channel 140, and the flow channel 140 may thus have a shorter length compared to the rotor 130.

According to certain implementations, the rotor 330 may have a compact configuration. The rotor 330 may for instance include a relatively short rotor body 331 and flow channel 140. Compared to other rotor bodies including an inlet spaced apart from multiple sets of flow straightener tubes, a subsequent flow path, and then a nozzle tip, the compact configuration of the rotor 330 may provide a rotor flow channel 140 with only a single set of flow straightener tubes 148 that are directly fluidly coupled to the rotor inlet at the inlet end 134 and the nozzle tip 137 at the rotor outlet end 136.

In addition or alternatively, the rotor 330 may be constructed of materials such as metal that add weight and durability to the rotor 330 when contacting the internal chamber in a high fluid pressure environment, and for instance one or more of the portions 332, 334, 335, and/or 336 of the rotor body 331 may be constructed of one or more of the metal-containing materials described herein, to provide weight to and adjust a center of gravity of the rotor 330. For instance, constructing the rotor 330 using a metal at the first portion 332, while using lighter or less dense materials at one or more distal portions may result in a weighted rotor having a high center of gravity. In another example, constructing the rotor using a metal at the third portion 336, while using lighter or less dense materials at proximal portions may result in a weighted rotor having a low center of gravity.

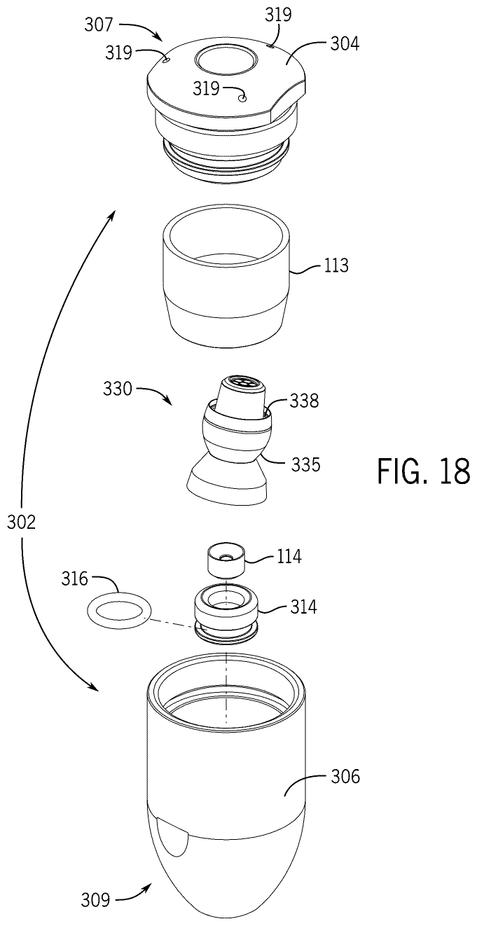

FIG. 18 shows an exploded isometric view of the nozzle 300. Assembly of the nozzle 300 may involve inserting the rotor 330 into the housing, optionally inserting the sleeve 113 into the second housing member 306, optionally inserting a sealing ring 316 onto the seat retainer 314, inserting the rotor seat ring 114 into the seat retainer 314, inserting the seat retainer 314 into the second housing member 306, coupling a sealing component to the first housing member 304, such as a sealing ring (see e.g., sealing ring 122), optionally attaching a nut 120 or fastener to an inlet member and to the first housing member 304, and attaching the housing members 304, 306 to each other, for instance, by inserting the first housing member 304 into the second housing member 306 such that the interior projection 305 seats against the sleeve 113, and securing the housing members such that they are non-detachably joined to one another, e.g., by inserting the nozzle 300 into a nozzle holder configured to receive and retain the nozzle 300 therein.

In FIG. 19, the cross-sectional view of the rotary spray nozzle 300 illustrates a representative flow pattern within the internal chamber 310 thereof. The nozzle 300 functions to deliver fluid from the discharge channel 119 during a spraying operation by receiving the fluid at the inlet member 108/308 from the supply line. The fluid is directed through the fluid channel of the inlet member 108/308 and travels to the fluid egress 308b where it enters the plurality of angled discharge channels or through holes 308c resulting in the fluid being delivered to the internal chamber 310 of the nozzle 300 at an angle via the top wall of the internal chamber 310, e.g., via the internal surface 111a. The fluid is directed against the surfaces 111a, 111b of the internal chamber 310 causing fluid pressure to be exerted on the rotor 330 resulting in the rotor 330 spinning and rotating within the internal chamber 310 against the rotor seat 115. Upon contacting the rotor body 331, fluid enters the inlet end 134 via the flow channel 140 and passes through the rotor inlet 142, rotor lumen 144 and finally exits the rotor outlet 146 (FIG. 4). Due to rotation of the rotor 130, the fluid exiting the rotor outlet 146 is in a substantially circular pattern. As the rotor 130 spins, the spherical region 335 serves as the contact portion 135 of rotor 130 and engages the contact region 112 of the internal chamber 310 generating friction to slow the spinning velocity of the rotor 130 such that the fluid exiting the rotor outlet 146 to facilitate maintaining a substantially continuous stream. The spherical region 335 may facilitate achieving a selected spray angle and rotational speed based on friction created with the internal sleeve 113 and/or internal surface 111b. At the same time, the fluid is forced into the external channel 338 of the rotor 330 resulting in forcing the outlet end 136 of the rotor 130 against the rotor seat 115, which may create or facilitate creating a fluid-tight seal between the rotor 130 and the rotor seat 115. While in the internal chamber 310, the fluid forces the rotor skirt 138 of the rotor 330 in the distal or angled distal direction resulting in forcing the outlet end 136 of the rotor 130 against the rotor seat 115, which also create or facilitate creating a fluid-tight seal between the rotor 130 and the rotor seat 115. The external channel 338 and rotor skirt 138 may each function to generate a fluid tight seal, however each may generate different amounts of sealing force for instance depending on the nozzle angle, rotor length, inlet configuration and so on. The rotor skirt relief channel 118 of the internal chamber 310 provides relief to the rotor skirt 138 enabling the rotor skirt 138 to move and rotate within the internal chamber 310, while forcing the outlet end 136 of the rotor 330 against the rotor seat 115. As a result of the forces exerted on the external channel 338 and the rotor skirt 138, the rotor outlet 146 is forced and seals against the rotor seat 115 to cause the fluid to exit the nozzle 300 through the discharge channel 119. Inclusion of the external channel 338 and the rotor skirt 138 may facilitate creation of the fluid-tight seal between the rotor 330 and the rotor seat 115 of the housing to prevent fluid from bypassing the rotor 330 and escaping the nozzle 300 before passage through the rotor outlet 146 (e.g., blow-by may be prevented), particularly at lower operational pressures compared to similar nozzles without the external channel and/or the rotor skirt. Further, the rotor skirt 138 may prevent fluid from reaching the discharge channel 119 of the nozzle 300 (e.g., preventing blow-by) such that the fluid moves within the internal chamber 300 and reaches the rotor inlet 142 for its eventual discharge through the channel 119.

In FIG. 19, the nozzle 300 may additionally function to deliver fluid from the rear discharge channels 319 during a spraying operation by receiving the fluid at the inlet member 308 from the supply line such that the fluid is directed through the fluid channel of the inlet member 308 and travels to the rear discharge channels 319 resulting in the fluid additionally being delivered from the nozzle 300 via the first housing member 304. For example, as shown in FIG. 19, the rear discharge channels 319 may be disposed at an angle 320 with respect to the longitudinal axis L around the inlet member 308. In some embodiments, the angle 320 may have a larger longitudinal thrust component (e.g., along the longitudinal axis L) than radial thrust component (e.g., along a radial axis R) than radial component. In some embodiments, the angle 320 may be about 5°, 10°, 15°, 20°, 25°, 30°, 35°, 40°, or 45° with respect to the longitudinal axis L. The nozzle assembly 300 may be propelled or urged along a conduit by the thrust of the stream 321 of fluid leaving one or more rear discharge channels 319, and as such, the cleaning fluid 141 exiting the rear discharge channels 319 may propel the nozzle assembly along the conduit. The streams 108 from the rear nozzles may also impinge on the interior wall of the conduit 107, to help clean the conduit (e.g., a trunk conduit or a sewer line). In other embodiments, the rear discharge channels 319 may be disposed at an angle 320 with respect to the longitudinal axis L such that the stream 321 leaving a particular rear discharge channels 319 has a greater radial thrust component than the longitudinal thrust component. Such nozzles may be configured to for instance clean the conduit but may also provide some motive thrust for the nozzle assembly 300, such as to urge the nozzle assembly 300 along the conduit.

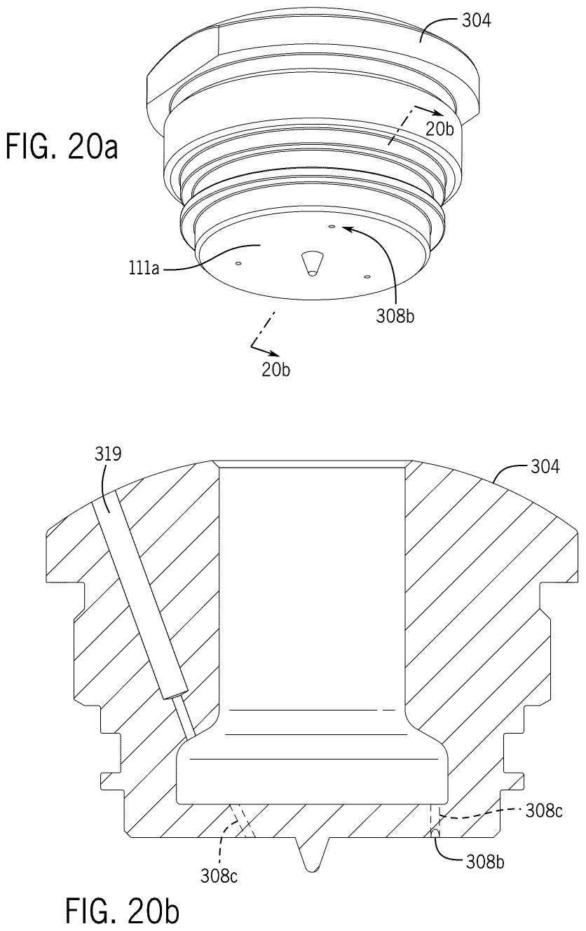

FIG. 20a illustrates an isometric view of the first housing member 304 of nozzle 300, and FIG. 20b illustrates a cross-section view of the first housing member 304 according to the present disclosure. The first housing member 304 may differ from the housing member 104 of the nozzles 100, 200 in that a plurality of angled discharge channels or through holes 308c are provided that are configured to discharge fluid directly into the internal chamber 310 via a bottom surface of the housing member 304, which may form the top wall of the internal chamber 310. Although FIG. 20a illustrates three angled discharge channels or through holes 308c, more or less angled discharge channels or through holes 308c may be provided. The angle of discharge from the angled discharge channels or through holes 308c may be selected to facilitate operation of the rotor 330 and may be directed an angle of about 15 to 45 degrees offset from the longitudinal axis L of the rotor body 331, such as about 30 degrees. In some cases, tangential discharge channels may be provided in the first housing member 304, which may be in addition or as an alternative to the angled discharge channels or through holes 308c and for instance, the nozzle 300 may be configured with the tangential discharge channels or through holes of the nozzles 100, 200. In addition, the first housing member 304 may include the rear discharge channels 319 as provided herein, which may facilitate propelling the nozzle 330 through conduits such as sewers during cleaning operations in which the nozzle 330 simultaneously delivers the oscillating spray via the discharge channel 119.

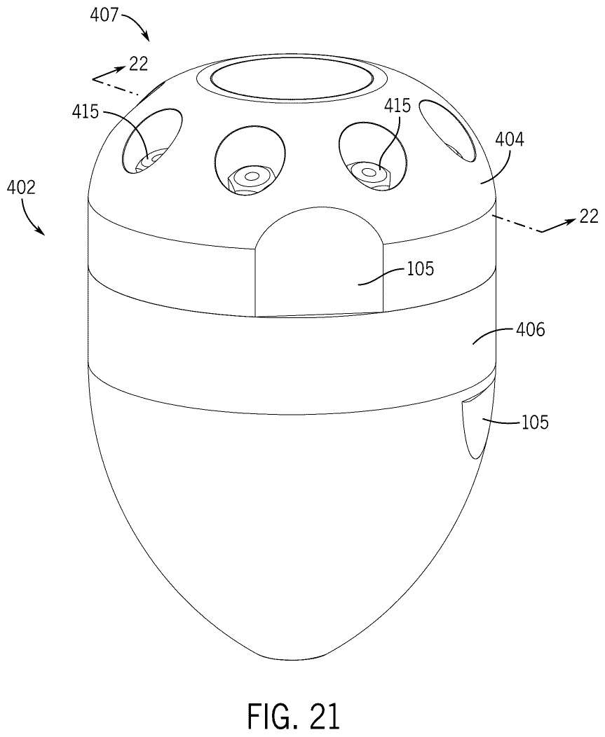

Referring to FIGS. 21 to 23b, illustrated is another embodiment of a rotary spray nozzle 400, according to implementations of the disclosure. The nozzle 400 may include elements that have been previously described with respect to the nozzles 100, 200 and 300 of FIGS. 1-20b. Various elements have been shown and/or identified in FIGS. 1 to 20b using the same reference numbers used in FIGS. 1-20b, and operation of the common elements is as previously described. Consequently, a detailed description of the operation of these particular elements will not be repeated in the interest of brevity.

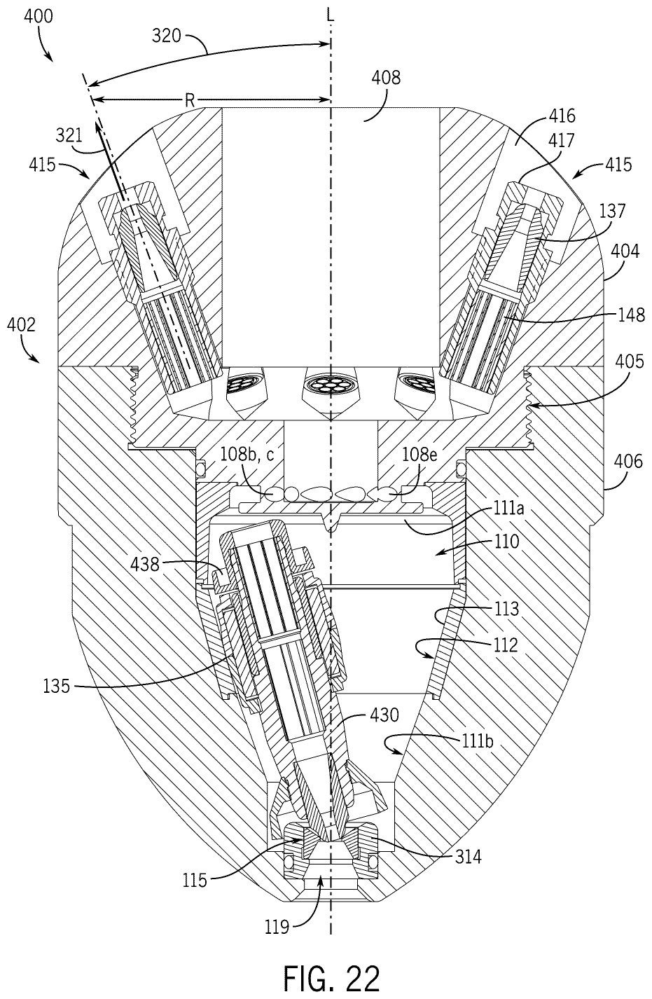

In FIG. 21, the rotary spray nozzle 400 may include a housing 402 with a first housing member 404 and a second housing member 406 that may be joined by a coupling 405 such as a threaded coupling, friction fit, spin welding or other coupling for securing the housing members 404, 406 to each other. The coupling 405 may be engaged by employing one or more facets 105 such that housing members 404, 406 can be secured in a wrench or vice such as for assembly, dis-assembly, maintenance, inspection, or the like. Rear nozzles 415 may be arranged in the first housing member 404, disposed about the inlet end 407 and fluidly coupled to the inlet member 408 (FIG. 22). The rear nozzles 415 may be disposed at an angle 320 with respect to the longitudinal axis L and radial axis R around the inlet member 408 similar to the rear discharge channels 319 of the nozzle 300 and may thus function to for instance clean a conduit, and may also provide some motive thrust for the nozzle assembly 400, so as to urge the nozzle assembly 400 along the conduit. A rotor 430 may be arranged in the internal chamber 110 of the rotary spray nozzle 400.

In FIG. 22, the first housing member 404 may include one or more apertures 416 that provide a receptacle suitable to receive the one or more respective rear nozzles 415. For example, the rear nozzles 115 may include external threads that mate with internal threads formed in the apertures 416. As shown for example in FIG. 22, the one or more apertures 416 may be in fluid communication with the inlet member 408. The inlet member 408 may be in fluid communication with the internal chamber 110. Thus, a portion of the fluid delivered to the nozzle assembly 400 may flow from the inlet member 408, into the apertures 416 and through the one or more rear nozzles 415. The rear nozzles 415 may be at least partially recessed within the apertures 416 so as to protect the rear nozzles 415 from damage. The rear nozzles 415 may be fluidically coupled with one or more flow straightener assemblies 148 and a converging section such as a nozzle tip 137, as discussed herein. The rear nozzles 415 may include a body 417 that may be configured to receive the flow straightener assemblies 148 and nozzle tip 137 therein and may be configured to be received by the aperture 416 of the first housing member 404.

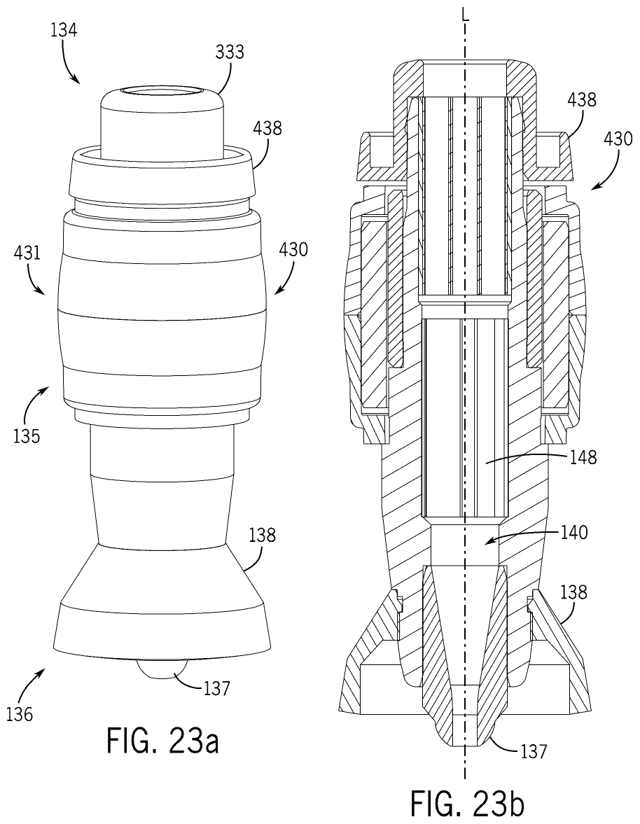

With reference to FIGS. 23a and 23b, the rotor 430 differs from the rotors 130 of the nozzles 100, 200 and the rotor 330 of nozzle 300 in that the rotor 430 of the rotary spray nozzle 400 may include an external channel 438 defined in a cylindrical or conical portion 333 of a rotor body 431 but may otherwise be configured similar to the rotor 130 of nozzles 100 and 200.

As shown in FIG. 23b, the external channel 438 may be formed with a cup-shape or trough having a flat bottom surface. The cup-shape of the external channel 438 (e.g., open box shape or flat bottom trough-shape) may have an open end facing the inlet end 134 of the rotor body 431 and a concave portion or closed end directed towards the outlet end 136 of the rotor 430, and a downward extension of the external channel 438 may extend parallel to the longitudinal axis L of the rotor body 431. An outer edge of the external channel 438 may define a lateral exterior sidewall of the rotor body 431 and may serve as part of the contact portion 135. An inner edge of the external channel 438 may join with a medial external sidewall of the rotor body 431. In some cases, the external channel 438 may be integrally formed with the cylindrical or conical portion 333 for instance as shown in FIG. 23b. Alternatively, the external channel 438 may be integrally formed with another portion of the rotor body 431, such as the contact portion 135. The external channel 438 may function similarly to the external channel 338 of rotor 330 and may receive fluid from the fluid inlet 408, e.g., via the tangential discharge channels or through holes 108c, such that some of the fluid in the internal chamber 110 is briefly retained in the external channel 438 and then flows back into the internal chamber 110. Due to the fluid being delivered at high pressures, the force of the fluid entering the external channel 438 forces the nozzle tip 137 at the outlet end 136 of the rotor 430 into the rotor seat 115 to facilitate forming a fluid tight seal therebetween. Accordingly, the external channel 438 and the flow channel 140 may not be fluidly coupled, but rather fluid exiting the external channel 438 may eventually be directed into the flow channel 140 and exit the nozzle 400. The external channel 438 may be constructed or formed of various materials including those of the present disclosure including polymers, composite materials, metals and/or metal alloys and may be injection molded or machined to impart durability to the external channel 438 when contacted by the high pressure fluid in the internal chamber 110. In some implementations, the external channel 438 may include a configuration similar to the external channel 338 of the rotor 330.

The nozzle assemblies of the present disclosure may include one or nozzles including the rotary nozzles 130, 230, 330, 430 and/or one or more rear nozzles 115 or discharge channels 119, 319. Any nozzles or discharge channels in the nozzle assemblies may concentrate, straighten, accelerate, and/or direct a stream of the fluid from the assemblies. For example, the nozzles may have a flow straightener assembly 148, and/or a converging section such as a nozzle tip 137 that converts potential energy in the fluid (e.g., pressure) to kinetic energy (e.g., velocity) (e.g., FIGS. 6 and 19). The nozzles may generate a thrust due to the reaction force of the fluid leaving the nozzle. The thrust may be substantially aligned with the flow axis of the nozzle from which a particular stream emanates. The thrust may be resolved into radial, longitudinal, or other components such as to imbue the nozzle assembly with certain cleaning or motion properties, such as spinning, and/or thrust.

Nozzles and nozzle components are also disclosed in commonly-owned U.S. Pat. No. 8,500,042, which is herein incorporated by reference for any useful purpose.

Various changes may be made in the form, construction and arrangement of the components of the present disclosure without departing from the disclosed subject matter or without sacrificing all of its material advantages. For instance, a distal portion of the housing may be fitted with a cover as is customary in rotary spray nozzle applications, which cover may facilitate fitting the rotary spray nozzle within a spray apparatus of a spray facility. The form described is merely explanatory, and it is the intention of the following claims to encompass and include such changes. Moreover, while the present disclosure has been described with reference to various embodiments, it will be understood that these embodiments are illustrative and that the scope of the disclosure is not limited to them. Many variations, modifications, additions, and improvements are possible. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A rotary spray nozzle, comprising:
a housing defining an internal chamber;
an inlet channel at a first end of the housing, the inlet channel configured to deliver fluid to the internal chamber;
a discharge channel at a second end of the housing opposite the first end, the discharge channel configured to discharge the fluid from the nozzle; and
a rotor arranged within the internal chamber, the rotor comprising:
a rotor body comprising an inlet end, an outlet end, and an internal flow channel extending therebetween for transmitting the fluid through the rotor body;
a cup-shaped external channel concentrically arranged about a longitudinal axis of an external surface of the rotor body, the external channel comprising an open end for receiving the fluid and a closed end for temporarily retaining the fluid; and
a rotor skirt arranged distal to the external channel and concentrically arranged about the longitudinal axis of the external surface,
wherein as the fluid enters the inlet channel and is discharged against a surface of the internal chamber, the fluid causes the rotor to spin and exerts force against the external surface of the rotor body as the fluid enters and is retained in the external channel and as the fluid contacts the rotor skirt, such that a rotor outlet at the outlet end is forced into and seals against a rotor seat of the housing, whereby the fluid from the rotor outlet is discharged from the discharge channel and assumes a generally continuous stream defining a circular spray pattern.

2. The rotary spray nozzle of claim 1, wherein the external surface of the rotor body defines a spherical region, and wherein the external channel is defined at a proximal end of the spherical region.

3. The rotary spray nozzle of claim 2, further comprising a sleeve positioned against the internal chamber, the sleeve defining a contact region configured to frictionally engage with a contact portion of the rotor body, the contact portion defined at least in part by the spherical region.

4. The rotary spray nozzle of claim 3, wherein the rotor skirt is arranged distal to the spherical region.

5. The rotary spray nozzle of claim 4, wherein the rotor skirt is at least partially received in a rotor skirt relief channel defined in a distal end of the internal chamber.

6. The rotary spray nozzle of claim 5, wherein the rotor skirt relief channel is arranged concentric to the discharge channel.

7. The rotary spray nozzle of claim 6, wherein a sidewall of the rotor seat and a sidewall of the internal chamber define the rotor skirt relief channel.

8. The rotary spray nozzle of claim 1, further comprising one or more angled discharge channels extending from the inlet channel, the angled discharge channels configured to deliver fluid to the internal chamber at an angle offset from a longitudinal axis of the housing.

9. The rotary spray nozzle of claim 1, further comprising one or more flanges extending from the inlet end to the external channel.

10. The rotary spray nozzle of claim 1, wherein the rotor skirt is at least partially received in a rotor skirt relief channel defined in a distal end of the internal chamber, and wherein the rotor skirt relief channel is arranged concentric to the discharge channel.

11. A rotary spray nozzle, comprising:
a housing defining an internal chamber;
an inlet channel at a first end of the housing, the inlet channel configured to deliver fluid to the internal chamber;
a discharge channel at a second end of the housing opposite the first end, the discharge channel configured to discharge the fluid from the nozzle; and
a rotor arranged within the internal chamber, the rotor comprising:
a rotor body comprising an inlet end, an outlet end, and an internal flow channel extending therebetween for transmitting the fluid through the rotor body;
a cup-shaped external channel concentrically arranged about a longitudinal axis of an external surface of the rotor body, the external channel comprising an open end for receiving the fluid and a closed end for temporarily retaining the fluid;
a spherical region arranged distal to the external channel and concentrically arranged about the longitudinal axis of the external surface; and
a rotor skirt arranged distal to the spherical region and concentrically arranged about the longitudinal axis of the external surface,
wherein as the fluid enters the inlet channel and is discharged against a surface of the internal chamber, the fluid causes the rotor to spin and exerts force against the external surface of the rotor body as the fluid enters and is retained in the external channel and as the fluid contacts the rotor skirt, such that a rotor outlet at the outlet end is forced into and seals against a rotor seat of the housing, as the spherical region contacts the surface of the internal chamber to provide frictional resistance to the rotor, whereby the fluid from the rotor outlet is discharged from the discharge channel and assumes a generally continuous stream defining a circular spray pattern.

12. The rotary spray nozzle of claim 11, further comprising a sleeve positioned against the internal chamber and defining a contact region for contacting the spherical region.

13. The rotary spray nozzle of claim 12, wherein the sleeve is formed of a material that differs from a material of the spherical region.

14. The rotary spray nozzle of claim 13, wherein at least a portion of the spherical region is formed of a metal.

15. The rotary spray nozzle of claim 11, wherein the spherical region extends along at least one-third of a length of the rotor.

16. The rotary spray nozzle of claim 15, wherein the external channel is arranged at a proximal end of the spherical region.

17. The rotary spray nozzle of claim 16, wherein the external channel and the rotor body are integrally formed, and wherein the spherical region is formed a different material therefrom.

18. The rotary spray nozzle of claim 16, wherein the external channel and the spherical region are integrally formed of the same material.

19. The rotary spray nozzle of claim 11, wherein the rotor flow channel includes a single set of flow straightener tubes extending from an inlet thereof, the flow straightener tubes directly fluidly coupled to a nozzle tip defining the rotor outlet.

20. A rotary spray nozzle, comprising:
a housing constructed of two housing members each formed of a polymeric material, the two housing members defining an external surface at an exterior of the nozzle and an internal surface, wherein the internal surfaces of the two housing members define an internal chamber;
an inlet member coupled to an inlet channel defined in a first housing member of the two housing members, the inlet member configured to deliver fluid to the internal chamber;
a discharge channel defined in a second housing member of the two housing members, the discharge channel configured to discharge the fluid from the nozzle;
a rotor arranged within the internal chamber, the rotor comprising a rotor body defined by an inlet end, a contact portion and an outlet end, wherein the contact portion is configured to frictionally engage a contact region of the internal chamber as the outlet end resides within a rotor seat of the second housing member at the discharge channel, the rotor body comprising a rotor flow channel defined by a rotor inlet, a rotor lumen and a rotor outlet,
wherein as the fluid enters the inlet member and is discharged tangentially against a surface of the internal chamber, the fluid causes the rotor to spin, and the contact portion and the contact region provide frictional resistance to the rotor such that the fluid discharged from the rotor outlet assumes a generally continuous stream defining a circular spray pattern.
